(19) United States
(12) Patent Application Publication
(10) Pub. No.: US 2014/0161691 A1
(43) Pub. Date: Jun. 12, 2014

(54) PROCESS AND DEVICE FOR BRINGING TWO IMMISCIBLE LIQUIDS INTO CONTACT, WITHOUT MIXING AND AT HIGH TEMPERATURE, WITH HEATING AND KNEADING BY INDUCTION

(71) Applicants: Jean-Pierre Feraud, ORANGE (FR); Xuan-Tuyen Vu, LANS-EN-VERCORS (FR); Florent Gandi, SAINT-ANDRE D'OLERARGUES (FR)

(72) Inventors: Jean-Pierre Feraud, ORANGE (FR); Xuan-Tuyen Vu, LANS-EN-VERCORS (FR); Florent Gandi, SAINT-ANDRE D'OLERARGUES (FR)

(73) Assignee: COMMISSARIAT A L'ENERGIE ATOMIQUE ET AUX ENERGIES ALTERNATIVES, Paris (FR)

(21) Appl. No.: 14/233,532

(22) PCT Filed: Jul. 19, 2012
(86) PCT No.: PCT/EP2012/064222

§ 371 Date: Jan. 17, 2014

(30) Foreign Application Priority Data
Jul. 21, 2011 (FR) 1156614

(51) Int. Cl. G21C 19/48; C22B 60/00; C22B 4/08

(52) U.S. Cl. CPC G21C 19/48; C22B 4/08; C22B 60/00
USPC 423/5; 75/10.14; 266/234

(57) ABSTRACT

The invention relates to a process and a device for bringing two immiscible liquids into contact, without mixing and at high temperature, with heating and kneading by induction. In particular, the invention relates to a process and a device for bringing into contact metals and salts which are molten at high temperatures, for example as high as approximately 1,100 K.

### TECHNICAL FIELD

The invention relates to a process and a device for bringing two immiscible liquids into contact, without mixing and at high temperature, with heating and kneading by induction. In particular, the invention relates to a process and a device for bringing into contact molten metals and salts at high temperatures, for example as high as approximately 1,100 K.

The technical field of the invention may be defined generally as that of the transfer of material, and more specifically as that of techniques for high-temperature chemical contact and separation, and more specifically of extraction involving immiscible liquids.

The technical field of the invention is, more precisely, but not exclusively, that of high-temperature liquid/liquid extraction systems, also called pyrocontactors, in which a phase of liquid salts and a phase of molten metal are brought into contact. The technical field of the invention is, notably, that of metallurgical processes in which actinides are extracted or back-extracted at high temperature, generally of around 800 K and as high as 1,200 K.

These processes are based on bringing an extractant metal, such as aluminium, in the molten state, into contact with two molten salt phases [1] [2].

### STATE OF THE PRIOR ART

Reprocessing by the conventional, “hydrometallurgical” means of nuclear fuels with high combustion rates requires cooling times of several years in order to reduce the content of radioactive elements responsible for radiolysis phenomena. High-temperature reprocessing by pyrometallurgy processes has the advantage of low sensitivity to radiolysis phenomena and a fuel cooling time of only several months.

The chemical principle of pyrometallurgy processes is based on the melting of an aluminium phase which is used as an actinides extractant medium [16].

Pyrocontactor devices allowing pyrometallurgical reprocessing by liquid/liquid extraction are thus described in documents [3], [4], [5], [6] and [7]. In these devices the liquid and molten metal phases are generally brought into contact continuously.

Documents [3-4] describe bulk packing columns, or a plate column using the molten chlorine/bismuth system.

The use of the extraction columns described in these documents is limited by the exchange kinetics. The HEPT (height equivalent to a theoretical plate) of these columns is generally between 1 and 2 m.

Document [5] describes a rotary packing column which is used, in particular, to bring a molten potassium chloride-aluminium chloride salts phase containing plutonium and a uranium-aluminium alloy into contact.

Document [6] describes mixer-settlers the technology of which, derived from hydrometallurgy, has been specially adapted to the field of pyrometallurgy.

The use of these mixer-settlers is limited by the efficiency of the settlement of two phases of similar specific gravities. The substantial dead volume of this type of equipment also requires the use of large quantities of reagents.

Document [7] describes a centrifugal pyrocontactor allowing immiscible liquid salts and liquid metals to be mixed and separated. The liquids are introduced into an annular mixing area and are vigorously mixed using vertical vanes attached to a rotor combined with deflectors. The liquids are introduced into the device at a temperature of 1,000 K to 1,100 K and are separated in the rotor into a dense phase and a light phase, both of which are evacuated from the device.

This device is used to treat the baths of molten chlorides derived from an electrorefining process.

The centrifugal extractor described in this document is an efficient device, but one which was tested over short periods, not exceeding several hundred hours in a molten chloride medium. Its reliability has not therefore been proven over a sufficient duration. Use of these devices is also limited by the appearance of corrosion problems which rapidly impair their operation.

In addition, outside the field of pyrocontactors and the nuclear industry, documents [8] and [9] describe the separation of immiscible liquids, particularly in the context of the extraction of oil contained in water.

These techniques use complex devices fitted with metal sieves and pumping systems with the aim of accomplishing a simple physical separation of two fluids without any aim of selective extraction of dissolved compounds.

The device and process of document [10] were developed in order to remedy the disadvantages of the processes and devices described in documents [1] to [7] mentioned above.

Document [10] relates to a contactor with an openwork wall which allows two immiscible liquid phases, such as a phase of molten alkaline fluoride and a phase of liquid aluminium to be brought into contact without causing them to mix.

In this device, therefore, the interfacial tension properties of molten aluminium allow this metal to be contained by means of the openwork wall.

This device may be used, notably, to bring an extractant metal, such as molten aluminium, into contact with two phases of molten salts, and by this means easily enables actinides to be extracted and back-extracted.

However, the existence of the openwork wall separating the two media limits and greatly slows the material transfer speed.

This limitation is mainly related to the diffusion of the chemical species through the openwork wall. This being so, thermodynamic equilibrium is generally reached after 12 h of contact/between the two phases.

In other words, the device described in document [10] has a material transfer kinetics, notably an extraction kinetics, which is greatly limited by the phenomena of diffusion through the openwork wall.

The openwork wall contactor described in document [10] is coupled with a “conventional” resistive heating system enabling work to be accomplished at a temperature of close to 1,200 K in an atmosphere with a controlled oxygen content and controlled humidity. This design allows liquid to be moved by convection at a speed of the order of one mm/min. on the molten salt side.

On the aluminium side, the very high thermal conductivity of liquid aluminium prevents a temperature gradient within this molten metal. The molten aluminium phase thus has a constant specific gravity at all points in the crucible, which prevents any kneading by free convection in this phase.

Limitation of the material transfer in the aluminium is thus mainly due to the diffusion of the species in the liquid metal, which is known to be a slow phenomenon.

In the case of a resistive heating system the speed of kneading by convection of the aluminium is thus close to zero.

One of the solutions to improve the kinetics and the kneading of the phases would consist in implementing a kneading of the mechanical type of the aluminium and of the molten salts.

The design of the pyrocontactor of document [10] does not facilitate this type of installation.

Mechanical kneading must also be monitored particularly closely in the area of the sealed passages, bearing in mind the stresses relating to the high temperature.

Finally, the option of mechanical stirring is rapidly limited by the wall effects, which greatly slow the flow of the liquids in the area of the geometrically constrained areas such as the windows of the contactor. These various considerations lead it to be concluded that such a solution is inefficient.

In addition, heating and kneading by induction is a well-known technique.

From an industrial standpoint, the use of an induction furnace is particularly widespread for heating metals.

In the nuclear field heating by induction was used in the context of the IFR (International Fast Reactor) project [17] with a view to purifying metallic uranium. This technology is still used at INL for reprocessing fuels of the EBRII “Experimental Breeder Reactor II” [18] in the part of the process called the “cathode processor”, the purpose of which is to evaporate molten chlorine residues contained in metallic uranium.

JAEA (Japan Atomic Energy Agency) also uses induction at the end of the process under operational conditions close to INL.

As part of the pyrometallurgical process, Hayashi et al. [19] have also developed an induction heating system intended to improve the corrosion resistance property of a crucible containing a molten salt. In this case the solution consists in using a technology close to that of the cold crucible.

Induction also allows a molten metal to be levitated, and prevents all contact with the crucible walls. This being so, a metal of high purity can be obtained. This property was used at Los Alamos [20] in connection with the reprocessing of fuel to obtain high-purity plutonium.

In addition, document [21] describes a furnace for melting insulating materials such as glass by direct induction in a cold crucible.

This melting furnace includes a cooled crucible with a continuous metallic sidewall, a sectorised and cooled hearth, and at least one inductor positioned under the hearth, which constitutes the sole means of heating the crucible. This document relates simply to melting of a glass, and does not relate to bringing two immiscible fluids into contact. No kneading of the glass under the effect of the induction is mentioned.

Document [22] relates to an electromagnetic device for melting and interfacial kneading of a diphasic system, comprising a first phase, or lower phase, and a second phase or upper phase, which are immiscible. This device notably allows metallurgical or pyrochemical processes to be accelerated.

More specifically, this device includes:
a crucible intended to contain the diphasic system;
melting and stirring means designed for melting the first and second phases and stirring the interface between them.
   These melting and stirring means include:
an inductor surrounding the crucible and
means of powering this inductor by a variable current having at least one component, where this component is able to stir the interface of the first and second phases.

The first phase may be a metal or an alloy, and the second phase may be a slag or a salt.

Tests are carried out with a zinc-based metal phase and a fluorinated saline phase, or again with a metal phase consisting of an Al—Cu alloy and a saline phase consisting of a blend of LiF and CaF₂. These tests have enabled it to be observed that, due to the interfacial stirring, the reducible elements are entirely transferred to the metal phase.

In this device the phases in contact are separated due to their property of immiscibility, and due to their differing densities, densities which cause, under effect of gravity, the phases to separate into an upper phase, for example a saline phase, and a lower phase, for example a metal phase.

As has been seen, the metal phase consists notably of an Al/Cu alloy which is denser than pure Al.

This Al/Cu alloy ultimately prevents the formation of a diphasic medium of the emulsion type, but the use of an Al/Cu alloy is not compatible in terms of the management of materials flows at the scale of a factory.

The devices using induction described above have not enabled the emergence of high-temperature liquid/liquid contactor systems able to be used directly to implement extraction processes.

There is therefore a need in light of the above for a process and for a device to bring two immiscible fluids into contact, such as a pyrocontactor, which is simple, reliable, safe and easy to use.

There is also a need for such a process and such a device, able to be used notably with molten metals and salts, which is highly efficiency and has optimum kinetics.

In addition, there is a need for a process and device for bringing immiscible fluids into contact and causing them to move, whilst controlling the accelerations to which the fluids are subject, and which requires only a very limited number of moving parts.

More specifically, there is a need for a process and a device for bringing immiscible fluids into contact, such as a pyrocontactor, which, whilst improving the material transfer kinetics of the openwork wall contactor of document [10], also retains all the established advantages provided by this openwork wall contactor technology.

In particular there is a need for a process and a device for bringing immiscible fluids into contact using the openwork wall contactor technology of document [10] which includes a kneading device which is simple to implement whatever the nature of the phases in contact and the working temperature range, and which allows a great improvement of the renewal of the liquid phases as far as the interface located in the openwork wall.

It would also be advantageous if this device were to be teleoperable to allow its use in nuclear containment chambers of the reinforced vessel (shielded casing) type.

The goal of the invention is to provide a process and a device for bringing two immiscible liquids into contact which meets these and other requirements.

The goal of the invention is also to provide a process and a device for bringing two liquids into contact which allow the use of two liquids of the same density, or of close or similar densities.

The goal of the invention is also to provide a process and a device for bringing two liquids into contact in which the liquids are heated by means of a compact heating system which limits the heating phenomena in a contained vessel.

The goal of the invention is also to provide such a process and such a device which do not have the disadvantages of the processes and devices of the prior art, and which solve the problems of the processes and devices of the prior art, and notably the problems of insufficient transfer kinetics through an openwork wall of the process and of the device described in document [10] (WO-A1-2008/080853), whilst retaining all their advantages.

### DESCRIPTION OF THE INVENTION

This goal, and others, are achieved, in accordance with the invention, by a process for bringing into contact, without mixing, a first material, consisting of a metal or of an alloy of several metals, in the liquid state, and a second material, consisting of a salt or a mixture of several salts, in the liquid state, said first material and said second material in the liquid state being immiscible, said first material being electrically conductive in the solid state and in the liquid state, and said second material being electrically conductive in the liquid state and possibly in the solid state, in which the following successive steps are carried out:

a) the first material, in the solid state, is placed in at least one first container comprising a wall made of a refractory solid material, which is not electrically conductive, transparent to a magnetic field created by at least one inductor, and not reactive with regard to the first and the second materials, said wall comprising one or more through aperture(s); the first material in the liquid state being non-wetting with regard to the said solid material of the wall;

b) the said first container is brought into contact with a volume of the second material in the solid state, placed in at least one second container made of a refractory solid material, transparent to a magnetic field created by at least one inductor, which is not electrically conductive, and not reactive with regard to the second material;

c) the first and second containers are subjected to the action of an electromagnetic field created by at least one inductor, by means of which induced electrical currents are generated in the first material in the solid state, and cause the first material to melt;

d) the first material in the liquid state starts to move under the action of Laplace forces;

e) the second material in the solid state starts to melt under the effect of a heat flux originating from the first container by conduction and radiation;

f) an ionic conductivity appears in the second material, allowing induced electrical currents to develop, which accelerate the melting of the second material;

g) the second material in the liquid state starts to move under the action of Laplace forces;

h) the first material in the liquid state being in contact with the second material in the liquid state at said apertures, the first material in the liquid state is left in contact with the second material in the liquid state for a sufficient duration for an exchange, transfer of material to occur between the first material in the liquid state and the second material in the liquid state;

i) the first container is removed from the volume of the second material in the liquid state;

j) the first container is cooled until the first material returns to the solid state.

The term “electrically conductive material” in the sense of the invention is generally understood to mean that this material has a conductivity of greater than 100 S·m⁻¹, and preferably greater than 1,000 S·m⁻¹.

The term “material transparent to a magnetic field” is generally understood to mean that there is no interaction between this material and the electromagnetic wave created by the inductor, and more specifically that this material has a maximum magnetic permeability of 10⁻³ H·m⁻¹.

The current passing through the inductor has advantageously an intensity of 100 to 3,000 ampere-turns, and preferably 100 to 1,000 ampere-turns, and has a frequency of 20 to 400 kHz, for example 200 kHz.

The current passing through the inductor advantageously has a frequency which is chosen so as to adjust the skin thickness for the first and second materials, according to the geometry of the first and second containers and the respective electrical conductivity properties of the first material and of the second material.

It should be stipulated, indeed, that only the first and second materials must be conductive, i.e. in the solid state and in the liquid state in the case of the first material, such as aluminium, and at least in the liquid state in the case of the second material.

The term “skin thickness” is generally understood to mean the thickness of the material at which ⅔ of the induced secondary currents are produced.

For example, the frequency of the current may be chosen such that the skin thickness is equal to half the value of the radius of the container, which is a crucible containing the less conductive material, which is generally the salt or salts, if this container is a cylinder with a circular cross-section.

The second container in which the second material is placed (material 2, salt(s), generally the less conductive material) advantageously surrounds the first container(s) in which the first material is placed (material 1, metal or alloy, generally the more conductive material), and the second container is closer to the inductor(s) than the first container (see, for example, FIG. 1A).

The induction frequency may advantageously be 200 kHz in the case of the geometry illustrated in FIG. 1A; under these circumstances the skin thickness in material 1 (molten metal) will be, for example, 1 mm, and the skin thickness in the molten salt will be, for example, 3 cm.

Under these circumstances (i.e. with a frequency of 200 Hz and the geometry illustrated in FIG. 1A), the injected power is advantageously distributed in proportions of approximately 50% between both materials, for example the injected power in material 2 (molten salt) is 51% and the injected power in material 1 (molten metal) is 49%.

The electromagnetic field created by the inductor advantageously generates a magnetic induction flux of between 10⁻⁶ and 10⁻³ Wb.

The electromagnetic field created by the inductor may advantageously be a sliding field.

Such a sliding field enables the efficiency of the heating and of the kneading to be improved.

To create such a sliding field several independent inductors may be present, where each inductor consists of a single turn, loop, through which a current passes.

Between each inductor the real part of the current is phase-shifted by 90° or n/2.

The term “refractory solid material” in the sense of the invention is generally understood to mean that this material can resist temperatures as high as 1,300 K without being degraded.

The refractory solid material constituting the wall of the first container is advantageously chosen from among boron nitride and alumina.

The density of the first material in the liquid state and the density of the second material in the liquid state are advantageously identical or similar.

One of the advantages of the process according to the invention is that it enables such phases, having identical or similar densities, to be managed.

The term “similar densities” is generally understood to mean that the density of the first material in the liquid state and the density of the second material in the liquid state do not differ by more than 10%, preferably by no more than 5%, and even more preferably by no more than 1%.

The first material in the liquid state is non-wetting with regard to the material of the wall of the first container, which generally means that its contact angle θ with the said wall is greater than 90°, and it is preferably between 120° and 180°.

The second material in the liquid state may be wetting or non-wetting, but it must preferably have primarily a wetting character with regard to the material of the separating wall, i.e. of the wall of the first container.

The process according to the invention includes a specific sequence of specific steps which has never been described or suggested in the prior art, as represented notably by the documents cited above.

The process according to the invention is simple, reliable and easy to implement. It satisfies the needs and requirements listed above, and provides a solution to the problems of the prior art mentioned above, and notably the problems posed by the process and the device described in document [10] (WO-A1-2008/080853).

In simplified terms, it is possible to say that in the process according to the invention, the following are combined in an unexpected manner: firstly the bringing into contact of a first material in the liquid state with a second material in the liquid state, separated by a wall including one or more through aperture(s); and secondly a system of heating by induction using the first material as a susceptor. In other words, the process according to the invention is differentiated from the process described in document [10] in that it uses the openwork-wall liquid/liquid contactor of this document, and combines it with a system of heating by induction using the first material as a susceptor, where this heating by induction is made possible due to the use of a refractory material which is transparent to the electromagnetic waves generated by an inductor to constitute both the first container or openwork basket, and the second container or crucible.

Compared to document [10], the replacement of the resistive heating system by an inductive system allows great improvement of the performances of the liquid/liquid contactor. Indeed, the improvement obtained due to the process according to the invention for the kneading speed of the second material is generally of an order of magnitude (of a factor 10) compared to the speed of kneading caused by free convection in the second molten material implementing a conventional resistive heating.

With the process according to the invention a speed of kneading of the second material (molten salts) of 3 cm/s, for example, is obtained, whereas a speed of kneading of the second material of only 2 mm/s is obtained with a conventional resistive heating.

As regards the first material (molten metal), the kneading speed increases by several orders of magnitude, since the expected values are close to some ten cm/s, whereas the resistive heating mode implemented in the prior art as represented by document [10] would not allow convective kneading of the first material to be installed.

Installation of kneading by induction therefore enables the contact time to be reduced by a factor of 10 to 100.

This time saving enables a state of equilibrium to be reached in a time which is generally less than 1 hour, for example in only 10 minutes, instead of 24 hours [10].

The use, to constitute both the first container and the second container, of a material which is transparent to the electromagnetic field generated by the inductor enables the first material i.e. the metal or the alloy of metals, to be used as a susceptor material.

Both containers may be made of the same material which is transparent to the electromagnetic field, or of different materials, both of which are transparent to the electromagnetic field generated by the inductor.

Such a material or such materials, used to constitute the containers, which have satisfactory transparency to the field lines, consequently interact(s) only slightly with the system of heating by induction, and the power delivered by the inductor is therefore mainly used to heat the first material in the solid or liquid state, and the second material in the liquid state.

It may be said that the process according to the invention consists, in an unexpected manner, in combining the liquid/liquid contactor technology forming the subject of document [10] (WO-A1-2008/080853) and the magnetohydrodynamics instead of a conventional resistive heating.

This combination enables the efficiency of the system described in document [10] to be greatly improved, and the productivity of such a system to be increased.

The process according to the invention takes advantage of the laws of magnetohydrodynamics to simultaneously accomplish kneading and electromagnetic heating of the molten materials.

The process according to the invention enables not only heating, but also kneading of the first and second materials, and relies on a double use of the properties of electromagnetism. Indeed, the laws of energy conservation allow a thermal effect (heating) to be combined with a fluid mechanics aspect (kneading).

The process according to the invention significantly improves the material transfer kinetics through the openwork walls of the liquid/liquid contactor described in document [10] by imposing a forced renewal of the liquid media at the interface between the first material in the liquid state (for example molten aluminium) and the second material in the liquid state (the molten salts).

This renewal within the through apertures or windows of the first container is possible due to the installation of electromagnetic kneading in the first and second materials in the liquid state, such as molten metals and salts.

Without wishing to be bound by any theory, the process according to the invention, in a surprising manner, uses the electromagnetic properties of the first material to use it also as a susceptor.

Indeed, according to one fundamental characteristic of the process according to the invention, it is not a wall of the first container or crucible which acts as the susceptor (the term “susceptor” is understood to mean a portion, part or element heated by the induced currents), as it is generally the case in processes using heating by induction.

In the process according to the invention, in a striking manner, it is the first material, which is a metal such as aluminium in which induced currents are generated, which acts as the susceptor. The second material consisting of salts also then acts as the susceptor when this second material has melted sufficiently and is sufficiently conductive for induced currents to be created in it.

The combination in the context of the process according to the invention, of the openwork wall system of document [10] (WO-A1-2008/080853) made from a specific material, notably a material which is refractory and transparent to the electromagnetic waves emitted by an inductor, with heating by induction using the first material as the susceptor, may be qualified as a synergic combination, having a whole series of unexpected effects and advantages; this combination notably allows:
the first and second solid materials to be heated and melted without contact, even if they have a high melting temperature, for example close to 1,100 K, as is the case of alkaline fluorides;
heating by induction enables the first and second materials, i.e. the metal, for example aluminium, and the salts, to be melted, despite them having very remote, different, electrical conductivities, for example different, remote, by three orders of magnitude;
a kneading of different phases to be accomplished: namely the phase consisting of the first material in the liquid state and the phase consisting of the second material in the liquid state;
the material transfer kinetics, for example extraction, to be accelerated;

In other words, due to the above-mentioned combination in the context of the process according to the invention:
a movement and a renewal of the liquid interfaces, i.e. interfaces between the first material in the liquid state (metal such as molten aluminium)/second material in the liquid state (molten salt(s)), are created as far as in the windows of the contactor and despite wall effects;
in a striking and advantageous manner the first material such as aluminium is made to have a double function: namely, firstly, the function of extractant, and secondly the function of heat source, which is due to its role of susceptor;
electromagnetic kneading is accomplished in metals having a high thermal conductivity, such as aluminium. In the case of resistive heating, the very satisfactory thermal conductivity of aluminium prevents the appearance of any temperature gradient. There may not therefore be any variation of density within the molten metal. Movements of liquid aluminium by convection are therefore impossible. The process according to the invention therefore ensures, in a surprising manner, that metals with high conductivity are kneaded, which was hitherto impossible with the processes using resistive heating;
electromagnetic kneading of the salt is accomplished, once it is melted, and by this means the speed of movement compared to free convection is improved very substantially, for example by a factor of 10;
a much greater speed of temperature rise is obtained, for example 10 times faster than when resistive heating is used;
due to the use of the inductive system it is possible to work in a temperature range which may go higher than 1,300 K without being constrained by the nature of the heating resistor of a conventional resistive system;
remote induction heating is used, which can easily be controlled by varying the power delivered by the generator,
the heat source is used in an optimal way, since this heat source is constituted by the first material such as aluminium, which acts as the susceptor, and which is generally positioned at the centre of the device, and not by the walls of the first or second container;
the heating zone and the kneading speeds are easily controlled through the choice of the frequency and of the operating current;
the possibility of causing two phases to move on either side of an openwork wall makes it possible to envisage a continuous extraction/back-extraction system by bringing into contact a metal such as aluminium, with two types of phase having the appropriate characteristics.

The induced electrical currents generated in the first material in the solid state cause the first material to melt, and the heat produced in this manner by the melting of the first material such as aluminium enables, in a second stage, the melting of the second material, consisting of salts, in contact with the first molten material, to be initiated.

The second material, when partially melted, then generally has a sufficient ionic conductivity, for example greater than 100 S·m⁻¹, for this second material to be directly heated by coupling of the magnetic field, and to be completely changed to the liquid state.

In addition to the heating of the first and second materials, the magnetic field induces Laplace forces which cause the forced convection within both materials in the liquid state.

The process according to the invention may be used easily, whatever the nature and temperature of the first and second materials, which are respectively metals or alloys, and salts.

The process according to the invention may be accomplished over a relatively short period, generally less than 1 hour, for example only 10 minutes, since the installation of kneading enables thermodynamic equilibrium to be reached in a short time.

In particular, the sufficient contact time of step h) may easily be determined by the man skilled in the art in this technical field, and is generally 2 to 10 minutes, and may be as much, for example, as 1 hour.

The process according to the invention may be accomplished both in a discontinuous operating mode and in a continuous operating mode. Indeed, the principle of the separation of the liquid phases, combined with causing the fluids to move by electromagnetic kneading, enables an operation of the “factory” type to be envisaged, in continuous mode. According to the invention, the interfacial tension of the triple point, first material in the liquid state/second material in the liquid state/solid material of the wall of the first container, is preferably high.

For example, the interfacial tension of the triple point: first material in the liquid state/second material in the liquid state/solid material of the wall of the first container, is higher than 0.3 N·m⁻¹, and preferably higher than 0.6 N·m⁻¹

In addition the first material in the liquid state advantageously has a surface tension of greater than 0.3 N·m⁻¹, and preferably greater than 0.8 N·m⁻¹.

Such a high surface tension enables the first material to be maintained in the liquid state in the containers when they are moved out of the second material, and prevents any loss of liquid by capillary flow out of the containers.

By this means, it is possible to work with openings, i.e. through apertures, the characteristic dimensions of which are of the order of one millimetre.

The said metal or the said alloy of several metals is advantageously chosen from among the reductive metals and alloys, such as aluminium and its alloys.

The salt(s) may advantageously be chosen from among the chlorides of alkaline metals, the chlorides of alkaline-earth metals, and the chlorides of aluminium, such as, for example, LiCl or AlCl₃; and the fluorides of alkaline metals, the fluorides of alkaline-earth metals, and the fluorides of aluminium, such as, for example, LiF, and AlF₃.

For example, an LiCl/AlCl₃ mixture or an LiF/AlF₃ mixture may be used.

After final step j) of the process according to the invention, it is possible to repeat steps b) to j), i.e. the first container may be put into contact with a volume of a third material, consisting of a salt or of a mixture of several salts, which is different from the second material.

The transfer (exchange) of material accomplished in the course of step h) may be any material transfer operation which may occur between two materials in the liquid state; the said material transfer between the first and the second materials in the liquid state is preferably a liquid/liquid extraction, during which one of the constituents of the second material in the liquid state passes into the first material in the liquid state and/or one of the constituents of the first material in the liquid state passes into the second material in the liquid state.

In particular, when a liquid/liquid extraction is accomplished, the said first material may be aluminium or an alloy of aluminium and the second material may comprise salts of fluoride of alkaline or alkaline-earth metals containing aluminium fluoride, and in which one or more actinide fluoride(s) and one or more lanthanide fluoride(s) are dissolved; and during step h) the said actinide fluorides are chemically reduced by contact with the molten aluminium or aluminium alloy to the said actinides (in the form of metals), which consequently pass into solution in the first material in the liquid state, whereas the lanthanide fluorides (non-reactive) remain in the second material in the liquid state.

After step j), steps b) to j) may then be repeated by bringing the said first container(s) containing the aluminium or aluminium alloy and the actinides metals into contact with a volume of a third material constituted by one or more chlorides of alkaline or alkaline-earth metals containing aluminium chloride, by means of which the actinides are chemically oxidised by contact with the said molten chlorides into actinide chlorides which pass into the third material in the liquid state (in the oxidised form of chlorides); and the reduction of the aluminium chloride enables the aluminium metal, which may possibly be reused for a new cycle of extraction/back-extraction, to be regenerated and recovered.

Steps b) to g) of the process of the invention are preferably accomplished in a primary vacuum of 10⁻² to 10⁻¹ absolute mbar when the two liquids are brought into contact, guaranteeing “intimate” contact between the two materials, notably in the liquid state, i.e. ensuring that the said gas pocket which may arise between the two phases is eliminated by this means.

Step h) of the process according to the invention is accomplished, preferably in an atmosphere of an inert gas such as argon, preferably preventing the presence of moisture and oxygen, and preferably at a pressure close to atmospheric pressure, notably in order to prevent the evaporation of the molten salt.

The invention also relates to a device for carrying out the process according to the invention, as described above; this device comprises:
one or more first container(s) intended to receive a first material in the solid or liquid state and comprising walls made of a refractory solid material, which is not electrically conductive, transparent to a magnetic field created by at least one inductor, and not reactive with regard to the first and the second materials, said walls comprising one or more through aperture(s); and the first material in the liquid state being non-wetting with regard to the said solid material of the walls;
a second container intended to receive a volume of a second material in the solid or liquid state, and comprising walls made of a refractory solid material, which is transparent to a magnetic field created by at least one inductor, non-electrically conductive, and not reactive with regard to the second material;
means to support the first container(s) containing the first material in order to bring them into contact with the said volume of the second material, and then to remove them from the volume of the second material;
means, constituted by at least one inductor, located outside the walls of the second container, to subject the first container(s) and the second container to the action of an electromagnetic field.
   It should be stipulated that the term “a material which is non-conductive of electricity” (not electrically conductive) is generally understood to mean a material having an electrical conductivity of <10⁻³ S·m⁻¹.

The device according to the invention has all the advantages and effects relating to the implementation of the process according to the invention which were mentioned above.

It is, notably, simple and reliable, and has very few moving parts, but is highly efficient. Its energy consumption is minimal.

It may be designed to be easily teleoperable in order to be used inside nuclear containment chambers, for example of the reinforced vessel type.

The device according to the invention may be designed both for an operating mode of the discontinuous type, which is particularly well suited for small quantities of material, for example 100 to 200 g of molten metal and molten salts, and for an operating mode of the continuous type to process larger quantities of materials.

Operation of the device in continuous mode requires that certain adaptations are made to it which will be understood by the man skilled in the art.

The said first container(s) and the second container are advantageously made of a material chosen from among alumina and boron nitride.

A preferred material is boron nitride.

Indeed, this material is chemically inert with regard to molten salts and molten metals such as aluminium; in addition boron nitride is only slightly wetting for aluminium.

It also has magnetic permeability of 4·π·10⁻⁷ H·m⁻¹, which procures satisfactory transparency with regard to the field lines.

The said apertures are advantageously as described in detail in document [10], and have a cross-section shape chosen from among circles; polygons, such as squares, rectangles, in particular rectangles having a high length/width ratio.

A preferred shape for the said apertures, notably if the first containers are cylindrical containers, is that of slits made in the base of the said containers, and which extend along the length of the sidewalls of the said containers.

The said first container(s) is/are advantageously (a) cylinder(s) with a circular cross-section, having sidewalls and a base or bottom wall, and the geometry of the base of the said first container(s) is preferably rounded in order to prevent the presence of dead volumes allowing the second liquid to diffuse under the first liquid, or in other words in order to limit the possible accumulation of the second liquid.

The said container(s) alternatively has/have an annular shape, and preferably the geometry of the base of the said first container(s) is rounded.

Advantageously the second container surrounds the first container(s) and the second container is closer to the inductor(s) than the first container(s).

The second container may advantageously be a cylinder with a circular cross-section having sidewalls and a base or bottom wall.

The device advantageously includes a single first container, a single second container and at least one inductor which are symmetrical relative to an identical vertical central axis.

In other words the device has an axisymmetrical configuration.

The device according to the invention may thus include a first cylindrical or annular container and a second cylindrical container, where the first container and the second container (or more precisely the sidewalls of both containers) are concentric, and where their main axes coincide.

The inductor is then preferably constituted by one or more circular turn(s) (loop(s)) surrounding the sidewall of the second container and concentric with it, where the main axis of this/these turn(s) coincide(s) with the main axes of the first and of the second cylindrical containers.

Such a geometry of the device or pyrocontactor according to the invention in the form of two concentric containers or crucibles enables the metal or the alloy to be immersed in the salt or salts.

This design is advantageous from the magnetic standpoint, since it thus enables the penetration of the lines into the two media to be turned to good account, in order to achieve improved distribution of the injected power.

The said means to support the said first container(s), to immerse them in the said volume of the second liquid, and to remove them from the said volume of the second liquid may advantageously comprise a vertical rod at the lower end of which an element supporting the first container(s) is attached.

The upper end of the vertical rod is preferably located in a remote zone subjected only to weak action of the electromagnetic field in order to allow it to be handled,

The said element supporting the first container(s) advantageously has the shape of a carousel or circular barrel, with a central axis which extends the said vertical rod, and where several first containers are positioned in a circle concentric to the central axis of the said carousel or barrel.

The said first container(s) is/are advantageously attached to the container support element by one or more key(s).

The said supporting element of the first containers may advantageously include in its centre a part which is preferably of a cylindrical shape protruding downwards beyond the base, bottom of the first said containers, and enabling the immersion depth to be controlled, and also enabling the dead volume in the container containing the second liquid to be limited.

The inductor advantageously consists of an induction coil, the turns, loops of which are positioned close to the walls of the second container, and notably close to its sidewalls when said second container is cylindrical.

The inductor is advantageously cooled, for example with water.

By this means a very compact device may be obtained, since the cooling of the inductor, for example with water, enables the thickness of the thermal insulators, installed around the walls of the second container, to be limited.

Cooling of the inductor also enables the thermal constraints imposed by operation in a reinforced vessel to be limited.

The invention will now be described in the following detailed description, notably in relation with particular embodiments, with reference to the attached drawings, in which:

### BRIEF DESCRIPTION OF THE DRAWINGS

FIG. 1A is a schematic cross-sectional side view of a model of a device according to the invention which was used for the modelisation of the device according to the invention;

FIG. 1B is a schematic cross-sectional side view of a model of a device according to the invention used for the axisymmetrical modelisation of the device according to the invention;

FIG. 2 is a cross-sectional side view of an embodiment of an openwork basket of the device according to the invention;

FIGS. 3A and 3B are cross-sectional side views of another embodiment of an openwork basket of the device according to the invention;

FIG. 4 is a schematic cross-sectional side view which represents the contact angle θ′ of the “triple” point defined between the first liquid (medium 1), the gaseous atmosphere present in the furnace, such as argon, and the solid wall of one of the openwork baskets at one of the slits of this basket;

FIG. 5 is a schematic cross-sectional side view which represents the contact angle θ′ at the triple point defined between the first liquid (medium 1), the second liquid (medium 2) and the solid wall of one of the openwork baskets at one of the slits of this basket;

FIG. 6 is a cross-sectional side view of an embodiment of the device according to the invention such as a pyrocontactor;

FIG. 7 is a cross-sectional side view of another embodiment of the device according to the invention such as a pyrocontactor;

FIG. 8 is a view of the container, openwork basket of the device of FIG. 7;

FIG. 9 is a vertical cross-sectional view along axis AA of the container, openwork basket of FIG. 8;

FIG. 10 is a three-dimensional perspective view of the container and basket of FIGS. 8 and 9;

FIG. 11 is a cross-sectional side view of yet another embodiment of the openwork device according to the invention such as a pyrocontactor, comprising openwork baskets supported by a barrel or carousel and immersed in molten salts;

FIG. 12 is a top view of the barrel or carousel of the device of FIG. 11 fitted with six openwork baskets;

FIG. 13 is a perspective view of the barrel or carousel of the device of FIG. 11 fitted with six openwork baskets with openings of different geometries;

FIG. 14 is a cross-sectional side view of the device similar such as a pyrocontactor according to the invention which shows the shape of the magnetic field lines generated by the inductor.

FIG. 15 shows the results obtained in example 1 during the axisymmetrical modelisation of a device according to the invention accomplished with the model of FIG. 1B. This figure shows the modelisation of the field lines.

FIG. 16 is a photograph which shows the kneading of the molten salt in a device according to the invention during tests undertaken in example 2.

FIG. 17 is a diagram which shows the movement of the surface of the molten salt photographed in FIG. 16, in 1 second.

The distance travelled is thus of the order of one cm.

### DETAILED DESCRIPTION OF PARTICULAR EMBODIMENTS

In the figures a given reference sign generally designates the same element.

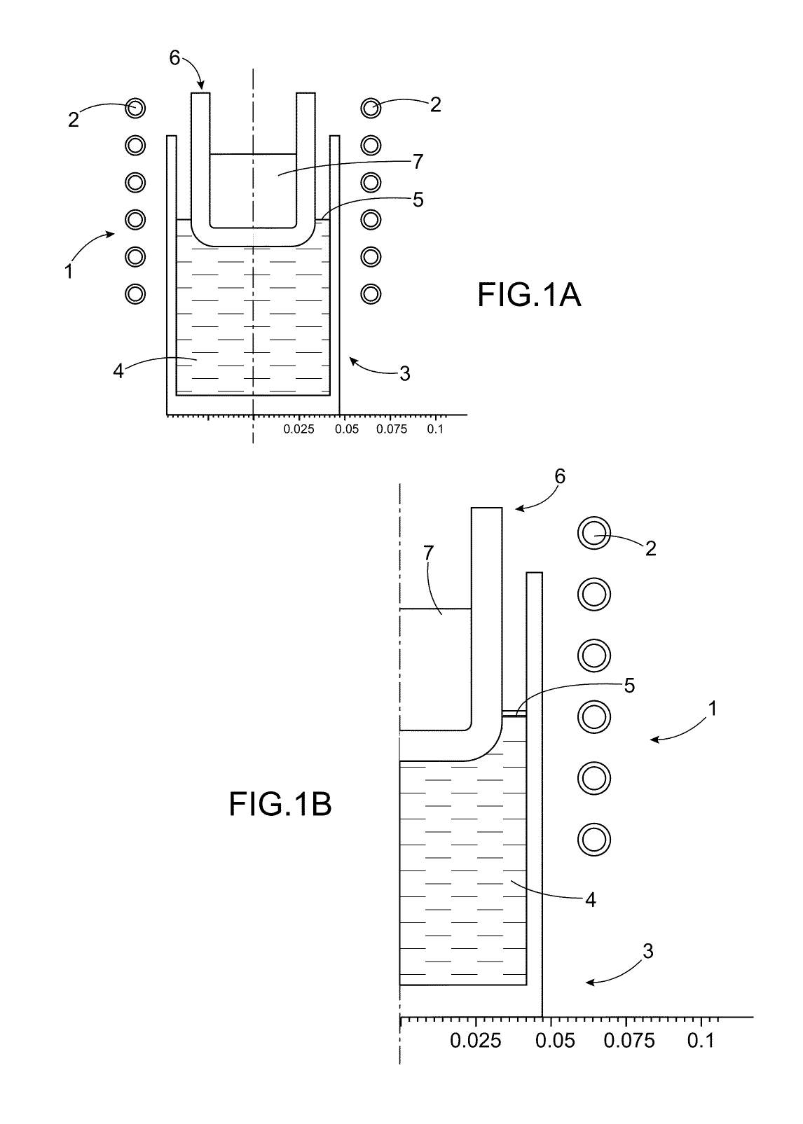

FIGS. 1A and 1B illustrate schematically the principle of the process according to the invention and a device for its implementation.

The device represented in FIGS. 1A and 1B firstly includes an inductor (1).

In FIGS. 1A and 1B this inductor (1) consists of an induction coil having a certain number of turns (2), where this inductor is connected to a generator (not represented).

The inductor may have 1 to 12 turns (2).

Thus, as an example, the inductor represented in FIGS. 1A and 1B has 6 turns, where the number, size and shape of the turns, and also the intensity and frequency alternating current of the current passing through these turns, may easily be determined by those skilled in the art, notably according to the shape of the magnetic field lines and the desired intensity of the magnetic field, which may range from 10⁻⁶ to 10⁻³ Wb, together with the volume of the crucibles and of the metals and salts used.

As an example, the current passing through the turns may range from 100 to 3,000 ampere-turns and its frequency may range from 20 to 400 kHz.

The device represented in FIGS. 1A and 1B also comprises a container or crucible (3), which is placed inside the said inductor (1).

This container or crucible (3) is intended to receive a second material (4), consisting of a salt or a mixture of several salts. These salts may notably be molten chlorides or fluorides, for example lithium fluoride, LiF.

This crucible (3) is generally made of a non-electrically conductive material, transparent to the electromagnetic waves emitted by the inductor (1), and is non-reactive with regard to the second material, notably with regard to the second material in the liquid state, and refractory.

The term “refractory” is understood to mean that this material may be brought into contact with the salt or mixtures of salts in the molten state at high temperature without being subject to degradations.

For example, this crucible (3) may be made of a material which can resist temperatures higher than 800 K, and possibly as high as 1,200 K.

This crucible may, for example, be made of boron nitride, for example made of boron nitride known as “HP or HIP grade” boron, or be made of alumina.

The second material (4), in the liquid state, i.e. the molten salt(s), generally rises as high as a level (5) represented in FIGS. 1A and 1B in the crucible. In FIGS. 1A and 1B the crucible (3) has a straight cylindrical shape, the sidewall of which is surrounded by the inductor and is concentric with the turns thereof.

The device according to the invention comprises, according to the schematic representation of FIGS. 1A and 1B, one or more openwork, perforated basket(s), container(s), crucible(s) (6) (in FIGS. 1A and 1B, the perforations have not been represented), which contain(s) the first material (7) consisting of a metal or several metals; when in the liquid state this first material comes into contact with the second material (4), which is also in the liquid state, contained in the crucible.

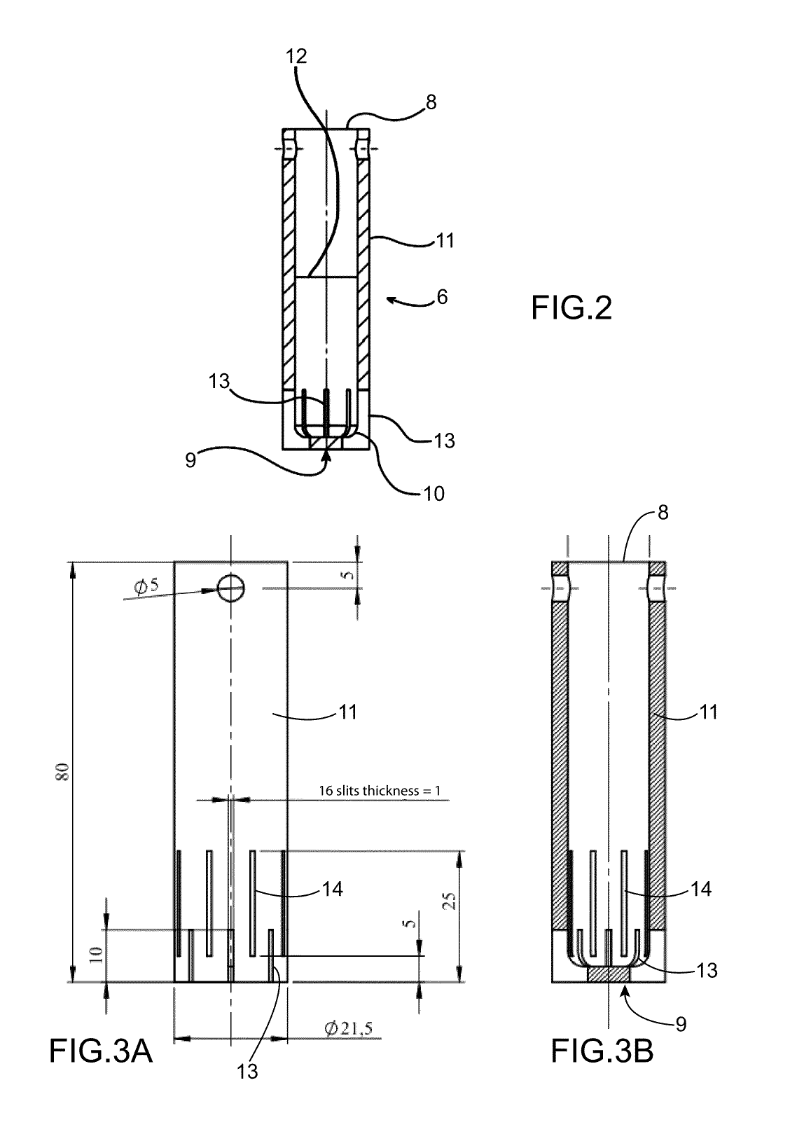

The openwork basket, crucible (6), as is shown in FIG. 2, may have a generally cylindrical shape, generally with a circular cross-section, and with an open top (8), and its lower wall or base (9) is preferably machined internally so as to be rounded (10), which prevents all dead volumes, and consequently any accumulation of the second liquid.

In other words, the connection between the sidewalls (11) of the basket (6) and its base, bottom, (9) is made through a portion of rounded wall (10).

The upper portion of the openwork baskets may however also be closed to prevent any contamination of the liquid such as a molten metal, contained in them up to a level (12), by vapours and condensates originating from the second liquid phase of molten salts contained in the “lower” crucible.

The basket(s) may also be closed by solidification, in the upper portion, of the first material in the liquid state contained in the basket.

In accordance with the invention, the wall and base of the basket consist of an inert material which is non-reactive with regards to both materials, and in particular to both materials in the liquid state.

This material constituting the baskets is also, in accordance with the invention, refractory, non-electrically conductive, and transparent to the electromagnetic waves emitted by the inductor (1).

The term “refractory” is understood to mean that this material may be brought into contact both with the metal or mixture of metals, and with the salt or mixtures of salts in the molten state at high temperatures without being subject to degradations.

For example, the basket(s) (6) may be made of a material which can resist temperatures higher than 1,000 K, and possibly as high as 1,500 K.

The basket (6) may, for example, be made of boron nitride, for example boron nitride of HP (High-Pressure) grade or of HIP (High Isostatic Pressed) grade, or of alumina.

The condition of low wettability of the material constituting the baskets by the first material in the liquid state 1 (contained), expressed by an angle θ greater than 90°, must of course be satisfied.

In accordance with the invention (FIG. 2), the walls (including the base, bottom) of the basket have apertures, openings (13), at which contact occurs, without mixing, between the first liquid phase contained inside the perforated, pierced, openwork baskets, and the second liquid phase which is located outside these baskets in the crucible.

The number, position, geometry and size of the openings (13) of the basket(s) may be modified, notably to allow an adjustment of the contact surface between the two liquid media. These modifications may, for example, improve the exchange kinetics of a liquid/liquid extraction process. Other geometrical modifications may be made to limit the retention of the liquids in the openwork baskets, at their openings, during the operations to change the medium during the extraction and back-extraction steps.

In the case, in particular, of cylindrical baskets, the section of the openings may have the shape of circles, squares or polygons, such as rectangles, preferably elongated rectangles, i.e. slits; these openings may be made on the sidewalls and on the bases of the containers such as cylinders as well.

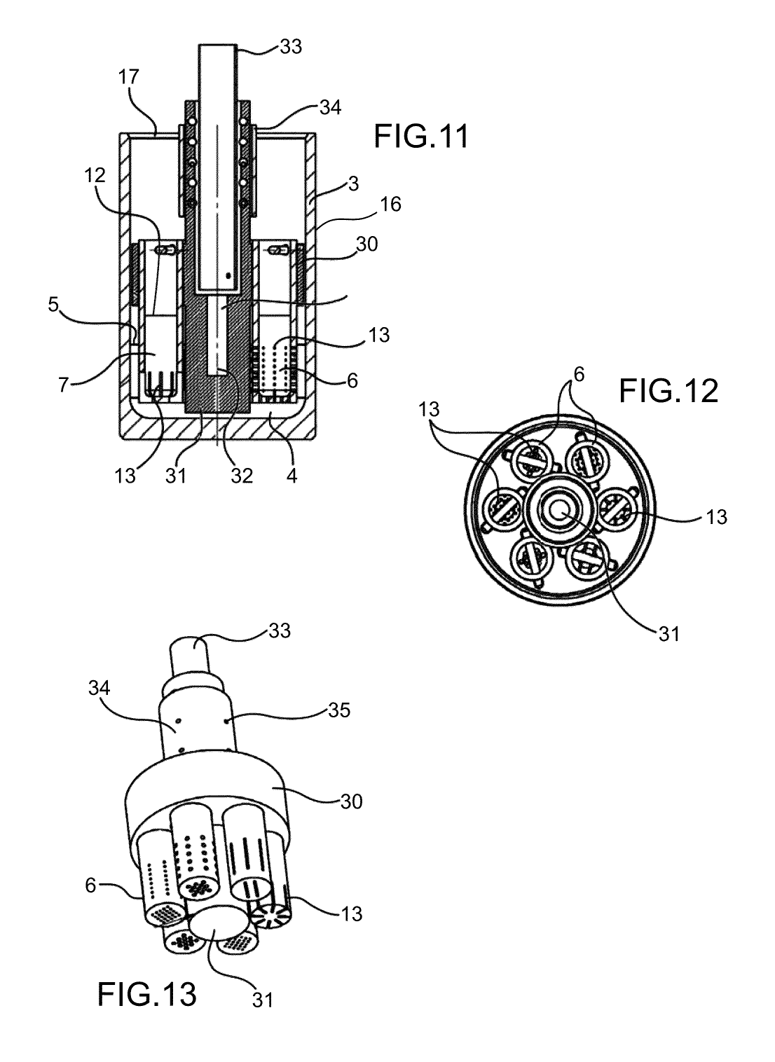

Various shapes which these apertures or openings (13) may take may be seen in FIGS. 11, 12, and 13, where each of the six baskets supported by the carousel has openings of different shapes, and in different numbers.

It should be noted that the carousel device of FIGS. 11, 12, and 13 is not the preferred embodiment of the device according to the invention, and these figures are simply given to show, in particular, the various shapes which the apertures of the baskets may take. One or more of the baskets represented in these Figures may, for their part, form part of a device according to the invention, whatever its embodiment, and then constitute its second container(s).

Indeed, if several baskets are used, all the baskets may have openings of different sizes and/or shapes, and/or in different numbers, or else two or more of the baskets may have openings of identical sizes and/or shapes and/or an identical number of openings.

It is clear that all the baskets may have openings of the same shape, of the same size, and in identical numbers, with the aim of facilitating handling and movement.

When a single basket is used, this basket may have openings of different sizes and/or shapes, such as those represented in FIGS. 11, 12, and 13, or else two or more of the baskets may have openings of different sizes and/or shapes, or else two or more of the baskets and preferably all the baskets may have openings of identical sizes and/or shapes.

For example, as regards the size of the openings in the case of cylindrical baskets, for example of a height of 100 mm and of a diameter of 21.5 mm, the circular openings will be 1 mm in diameter and the slits will be 19 mm in length and 1 mm wide.

Among the many possible geometries, the shape of the openings of the baskets represented in FIG. 2 which are constituted by openwork slits or windows (13) which are, for example, 1 mm wide, starting in the bottom wall of the basket at an interval, for example, of 0.8 cm from the edge and reaching, for example, up to 15 mm high on the sidewall (11) (in the case of cylinder-shaped baskets having, for example, a height of 100 mm and a diameter of 21.5 mm), allows gas bubbles to be evacuated when the two molten media are brought into contact in a controlled atmosphere.

This particular configuration of the openings is an improvement compared with openwork baskets having openings of simple shape, such as circles.

Another possible geometry, for the openings of the baskets, is represented in FIGS. 3 (A and B). The basket of FIG. 3 follows the geometry of the slits or windows (13) of FIG. 2 and also contains slits or windows (14) on the sidewall between the portions of the slits (13) located on these sidewalls.

The geometry of the openings of the baskets represented in FIG. 3 allows the contact area to be increased by a factor of 3 compared to the geometry of the openings represented in FIG. 2.

Use of the process according to the invention is facilitated when one of the two materials in the liquid state, preferably the one within the openwork baskets, has a high surface tension value, i.e. a surface tension greater than 0.3 N·m⁻¹; this is so, for example, for molten aluminium at 933 K [11], which has a surface tension value of 0.87 N·m⁻¹.

It should be recalled that surface tension is the tension found at the surface of the liquid, or rather at the interface between the said liquid and the gaseous atmosphere present in the furnace.

It is defined as the force which must be applied to the unit of length along a line perpendicular to the surface of a liquid in equilibrium to cause this surface to be extended, or as the work exerted by this force for each unit of area. The surface tension unit (N·m⁻¹) is equivalent to joules per square metre (J·m⁻²), which correspond to one unit of surface energy.

Such a characteristic is important since it enables the first liquid to be kept in the baskets, without any loss or flow, when moving the baskets (by raising with the rod described below) in the atmosphere, for example of argon, of the furnace between the immersions in the different liquid media, such as molten salts, used to undertake, for example, the steps of extraction of the actinides present in the fluoride solutions, followed respectively by back-extraction in a medium of molten chlorides.

The maximum hydrostatic height is the maximum height of the column of the first liquid able to be received in an openwork basket used according to the invention, this hydrostatic height being dependent, notably, on the geometry of the apertures or openings of this basket.

As described in document [10], the maximum hydrostatic height may be calculated in two cases: the first is the case in which the baskets are raised, not immersed, and in which the first liquid or liquid “1”, such as molten aluminium, contained in these baskets is in contact with the gas, such as argon, constituting the atmosphere of the furnace.

The second case is the one in which the openwork baskets are in contact with the second (or third) material in the liquid state, such as molten salts.

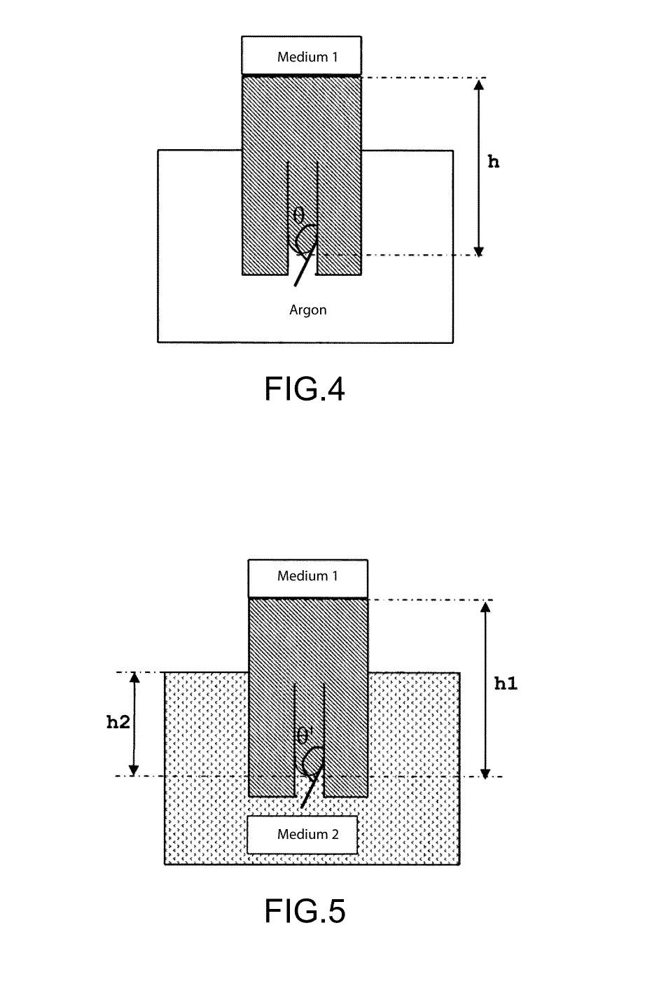

This maximum hydrostatic height may be calculated in the first case using a Young-Laplace equation which may be qualified as a “simplified” Young-Laplace equation, in which use is made of the surface tension at the surface of the liquid, or rather at the interface between liquid “1” contained in the basket, such as molten aluminium, and the gaseous atmosphere present in the furnace, during the steps of raising and moving the baskets. This atmosphere consists, for example, of a primary vacuum or of argon (FIG. 4).

The simplified Young-Laplace equation is given below [12] (Equation n^{o} 1):

$$ρ \cdot g \cdot h = \frac{2 \cdot γ}{r} \cdot cos θ \qquad ( Equation n°1 )$$

where:
ρ: Density of the first liquid, Kg·m⁻³,
g: 9.81 m·s⁻²,
h: Height of the liquid, m,
γ: Surface tension of the liquid, N·m⁻¹ (or J·m⁻²),
r: Radius of the capillary, or distance between two parallel plates,
θ: Contact angle of the liquid interface with the solid wall (parallel plates or capillaries depending on the shape of the openings).

Equation n^{o} 1 makes it possible to dimension openings of openwork baskets allowing different heights to be contained, of first material in the liquid state, for example of molten aluminium, without any back pressure of a second material in the liquid state, such as a molten salt.

Examples of calculations of equilibrium heights “h” are given in Table n° 1 below for various basket opening geometries for aluminium, where:

ρ Al: 2,700 Kg·m⁻³,
g: 9.81 m·s⁻²,
h: Maximum height of the liquid in equilibrium (calculated),
γ: 0.87 of N·m⁻¹ (or J·m⁻²) [12],
r: Radius of the hole, or distance between parallel plates,
θ: 160° (Al/boron nitride contact angle) at the temperature of 1,100 K for boron nitride ([14], J. Mater Sci 2007)):

TABLE NO. 1

| | |
|---|---|
| circular geometry | window geometry |

molten metal

| | Al | Al | Al | Al |
|---|---|---|---|---|
| crucibles | 1 | 2 | 3 | 4 |
| r | 0.2 cm | 0.1 cm | 0.05 cm | 0.1 cm |
| calculated h values | 3.1 cm | 6.2 cm | 12.3 cm | 6.2 cm |

The heights values given in Table n^{o} 1 were calculated using equation n^{o} 1.

In this case only the absolute value of “h” is important, which makes it possible to envisage working with columns of liquids (molten Al) of between 3 and 12 cm.

The analytical calculation does indeed give negative “h” values since aluminium does not wet boron nitride.

For the aluminium/boron nitride system these results must be considered to be guide values. Indeed, the contact angle between aluminium and ceramic BN may become smaller when the operating temperature exceeds 1,100 K ([14], J. Mater Sci 2007).

Under these conditions the BN reacts with Al to form AlB₂ and AlN which degrade the non-wettability properties. It is therefore advisable to work within a temperature range of <1,100 K.

If the second case is considered, when the baskets containing the first liquid such as molten aluminium are in contact with a second (or third) material in the liquid state such as a bath of molten salts, the property of metal/salt/solid interfacial tension replaces the property of metal/gas/solid surface tension.

The new value of the contact angle θ′ to be taken into account for the calculation must also relate to this new triple point, as is represented in FIG. 5.

Finally, an assessment of the hydrostatic pressures at the triple point must be made according to equation n^{o} 2, below:

$${ρ}_{2} \cdot g \cdot {h}_{2} - {ρ}_{1} \cdot g \cdot {h}_{1} = \frac{2 \cdot {γ}_{12}}{e} \cdot cos {θ}^{′} \qquad ( Equation n°2 )$$

where:
ρ: Density, Kg·m⁻³ (ρ₁=2,700 for example for Al, ρ₂ #2,700 for example for the molten salt),
g: 9.81 m·s⁻²,
h: Height of the liquid, m (h₁=for example Al, h₂=for example molten salt),
γ₁₂: Interfacial tension, for example salt/metal/solid support, N·m³¹ (or J·m⁻²),
e: Radius of the capillary, or distance between two parallel plates (m),
θ′: Contact angle of the liquid interface with the solid wall (parallel plates or capillaries).

In the context of the use of aluminium/molten fluorides system, we have ρ₁ # ρ₂ # ρ, taking h₂=h₁+Δh, and equation n^{o} 2 becomes:

$$Δ h = \frac{2 \cdot {γ}_{12}}{ρ \cdot g \cdot e} \cdot cos {θ}^{′} \qquad ( Equation n°3 )$$

In the case shown above it is possible to calculate the limiting hydrostatic height of the aluminium contained in the openwork baskets for each opening geometry. A few examples are given in table n^{o} 2 below, taking a value γ₁₂ of 0.72 N·m⁻¹ (at 1,000 K) with a contact angle “θ′” of 180° [13] at the aluminium/(LiF/AlF₃)/solid alumina triple point. Examples of calculations of equilibrium height are given in table n^{o} 2 below:

TABLE NO. 2
Effect of opening geometry on limiting hydrostatic height

| | | |
|---|---|---|
| Radius of hole/or gap between plates | 0.05 cm | 0.10 cm |
| Δh equilibrium (equation no 3) | 6.95 cm | 3.47 cm |

Regarding the use for a given material, the best compromise must be made between the hydrostatic height, i.e. the quantity of material to be processed, and the exchange surface of the openwork baskets, i.e. the transfer efficiency.

Similarly, as the extraction progresses, if the bringing into contact consists of an extraction, modifications are observed of the density of the liquid (due to the material transfer) contained in the baskets. This phenomenon must be taken into account when dimensioning the openings of the openwork baskets.

In the schematic drawing of FIGS. 1A and 1B used to model the device and process according to the invention, the supporting element or part, in other words the system for holding and raising the basket(s) containing the first material such as aluminium, has not been represented, since this system has no influence on the electromagnetic properties.

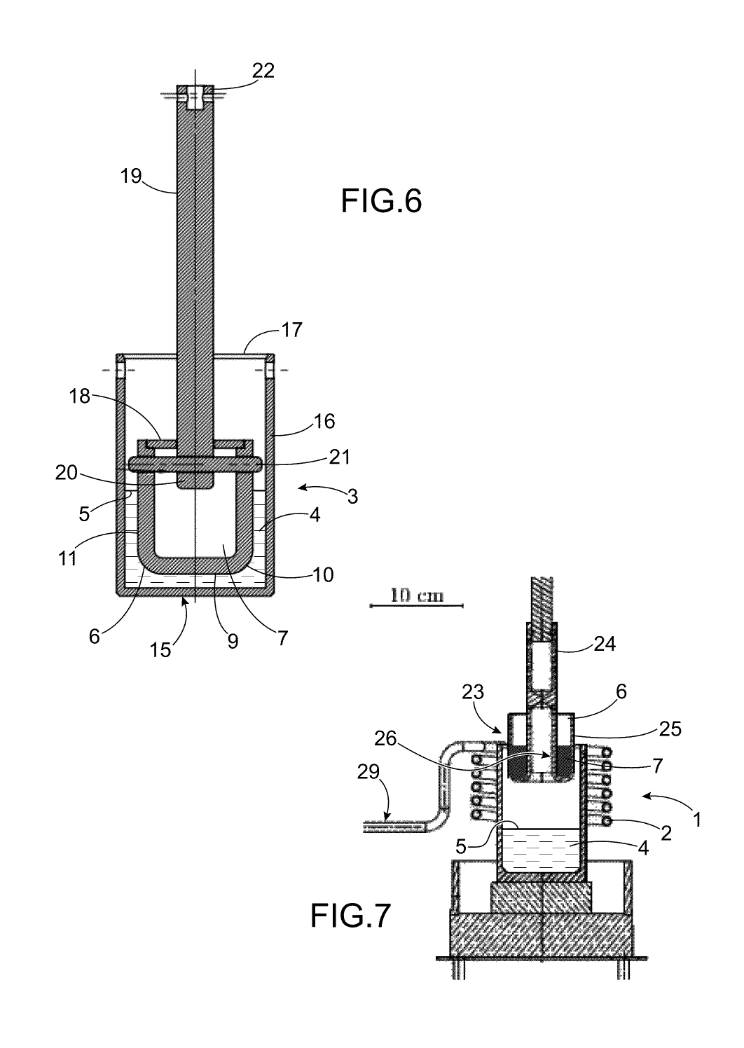

Indeed, the perforated openwork basket(s) is/are therefore generally attached to a supporting element or part which enables it to be brought into contact with the second material or third material and then enables them to be taken out of the second material or the third material in the liquid state. The supporting material has no effect on the field lines. Thus, in FIG. 6, an embodiment of the device according to the invention has been represented in which the crucible (3) containing the second material (4), i.e. the salt(s), has the shape of a straight cylinder with a circular cross-section, with a base (15) and a sidewall (16); this crucible has a cover (17).

The openwork basket or crucible (6) containing the first material (7), such as aluminium, is placed inside the said crucible.

This basket (6) has the preferred shape described above, i.e. a generally cylindrical shape, generally with a circular cross-section, with a lower wall or base, bottom (9) machined at the lower part thereof so as to be rounded (10). In FIG. 6 the basket has a cover (18).

The device represented in FIG. 6 also includes a supporting element or part, in other words a system for holding or raising the openwork basket.

This system includes a vertical rod (19) one end (20) of which is integral with a horizontal part (21) attached to the sidewall (11) of the basket and the other end (22) of which is connected to an actuation device (not represented) enabling the basket to be lowered and raised (6).

The inductor (not represented) is placed outside the crucible (3) and the generally circular turns of the inductor generally surround the sidewall of the crucible (3) as in the device of FIG. 7.

In other words, the turns of the inductor, the sidewall of the crucible (3) and the sidewall of the basket (6) are concentric.

In FIG. 7, another embodiment of the device according to the invention has been represented in which the openwork basket (6), containing for example aluminium (7), has the shape of an annular container (23) attached to a rod (24) by means of a metal bar or pin positioned in a field zone where there is no risk of its being heated.

The second material in the liquid state (4) is therefore in contact with the first material (7), on the outer wall (25) of the annular basket and also on the inner wall (26) thereof.

The embodiment of the device according to the invention represented in FIG. 7 therefore has the advantage of a larger exchange surface.

In FIG. 7, the inductor (1) has also been represented, which is placed outside the crucible (3) and which takes the form of circular turns (2) surrounding the crucible and powered by a cable (29) connected to a generator (not represented).

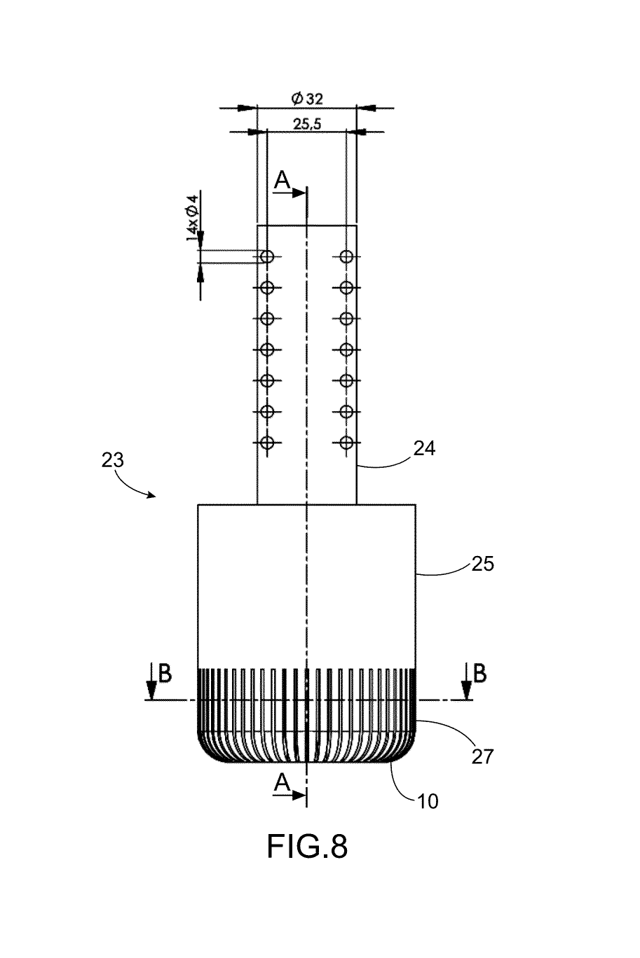

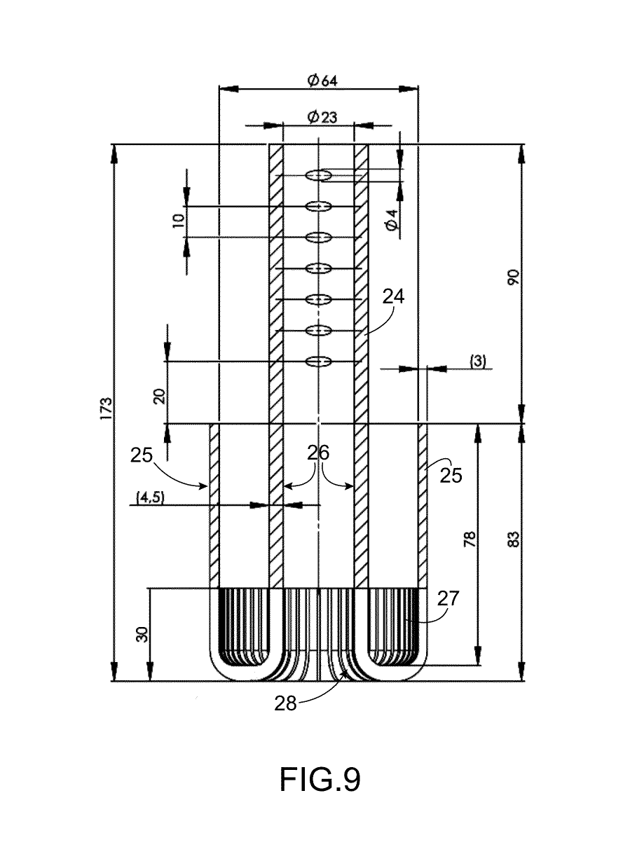

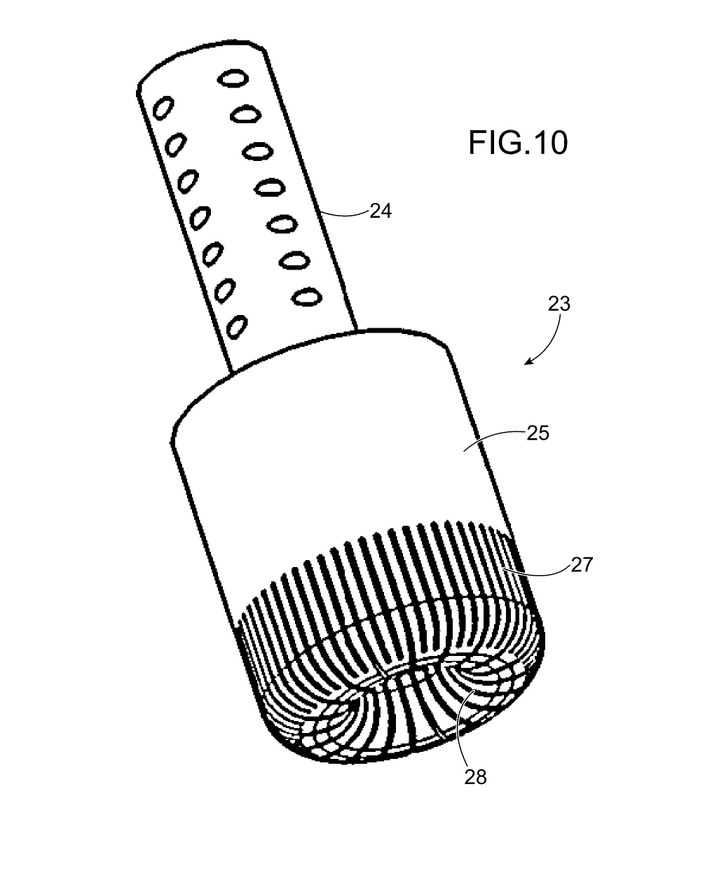

The openwork annular basket or container (22) of the device of FIG. 7 is represented more accurately in FIGS. 8, 9, and 10.

This openwork basket or container (23) may consist of a single block of mass-machined boron nitride; it has fifty contact windows (27) on the outer wall side (25) and 19 openwork windows (28) on the inner wall side (26).

This “monolithic” equipment obviates the need to assemble parts subjected to high temperature fields.

This embodiment of the device according to the invention is substantially similar to the embodiment of the device of application [10] WO-A1-2008/080853 described in FIGS. 1 to 3 of this application, with the fundamental difference, however, that the device according to the invention is fitted with an inductor (not represented) and that the materials of the crucible and of the baskets are chosen so as to be transparent to the magnetic field generated by the inductor. It should be noted that the embodiment of the device according to the invention shown in FIGS. 11, 12, and 13 is not the preferred embodiment of the device according to the invention, which must preferably be axisymmetrical.

However, one or more of the baskets represented in these FIGS. 11, 12, and 13 can be taken separately to form part of a device according to the invention, whatever the embodiment and then to constitute its second container(s).

The device according to the invention in the embodiment of FIG. 11 comprises firstly a container or crucible (3) intended to receive the second material (4) which consists of a salt or of several mixed salts. When liquid, the second material rises as far as a level (5).

The crucible (3) generally takes the form of a straight cylinder with a circular cross-section with a sidewall and a base, bottom. The device of FIG. 8 comprises an inductor which generally has circular turns surrounding the sidewall of the crucible (3), and which are concentric with said sidewall.

The device according to the invention in the embodiment of FIG. 11 also includes several openwork or perforated baskets (6) already described above, which contain the “first” material in the solid state and subsequently in the liquid state (7) which must be brought into contact with the second material in the liquid state (4) contained in the crucible (3).

These openwork or perforated baskets (6) are attached to a supporting element, which may be called a caroussel or barrel (30).

In FIGS. 12 and 13, the caroussel or barrel (30) supports six openwork, perforated baskets (6), but a different number of baskets, whether higher or lower, may quite clearly be used.

Such a caroussel may support, for example, 1 to 6 basket(s); the unused basket(s) must then be replaced by an equal number of baskets made of a solid material (boron nitride, alumina, etc.) in order to maintain properly controlled heights of liquids and exchange surfaces.

The basket-supporting caroussel or barrel (30) also includes a central portion or part (31) which in FIG. 11 is represented immersed in the second liquid such as a molten salt inside the crucible. This central part (31), which is generally of cylindrical shape, protrudes beyond the base of the containers or baskets (6).

The illustrated barrel or caroussel system enables the type and nature of the openwork baskets, each one of which is supported by a simple key, to be quickly changed.

The central portion or part (31) of the caroussel (30) is hollowed-out (32) and may possibly house a thermocouple and/or a thermal bridge.

A metal rod (33) may thus be placed for this purpose in this central hollowed-out portion (32) of the caroussel or barrel (30).

The central portion or part of the openwork baskets support, or barrel or caroussel, (30) is therefore immersed in the “second” liquid such as molten salts in order to cause a local cooling of the liquid, by a few degrees.

Another advantage of the immersed central part (31) is that it reduces the “dead” volume in the crucible containing the second liquid such as molten salts. Such a design enables an openwork baskets volume to crucible volume ratio of close to 1 to be obtained.

The central portion (31) also enables a safety stop to be constructed, and the height positioning of the caroussel to be controlled in the system when at temperature, i.e. in the system raised to the working temperature, which is notably a temperature at which the metal and salt phases of each of the respective liquids melt.

By modifying the geometry of the immersed central portion (31) the volume or mass ratio of the phases in contact can be changed, and the process's operating conditions can be optimised.

As an example, the immersed central portion (31) of the barrel or caroussel may have a star-configuration geometry or a polygonal geometry.

The assembly constituted by the barrel or caroussel and the openwork baskets is held in the rod (33) using pins.

The upper portion of the caroussel penetrates into the annular space of the (non-metallic) rod (33) and (34), and by this means is held in a stationary position.

The rod, which may be qualified as a “lifting rod”, and which is fitted to the furnace, such as a pit furnace, in which the device according to the invention is placed, enables the caroussel and the baskets which are attached to it to be raised and moved, in order to bring it into contact with different media, for example different salts or mixtures of solid salts which are then melted.

The holding rod (33) (34) of the assembly formed by the barrel and the baskets may be connected to a device-independent (remote) rotation system, which by this means allows dynamic kneading of the liquid medium contained in the crucible. Use of such kneading increases the device's efficiency further.

The upper portion of the crucible where the second liquid, such as molten salts, is located may be closed by an insulating cover (17). This cover (17) is crossed by a double-envelope rod seen as a cross-sectional view as (33) and (34). Fixing holes (35) are provided on the outer sleeve of the rod (34) at the crossing of the cover which allow the caroussel assembly of the pyrocontactor to be positioned at a certain height using pins.

The device according to the invention as described for example in FIGS. 1A, 1B, 6, 7, 8, 9, 10, 11, 12 and 13 may operate in a discontinuous mode which is particularly suitable for use in a reinforced vessel with small quantities of materials (for example 100 to 1,000 g of molten salts and molten metal). Use of larger quantities will however be able to be possible provided adaptations are made allowing operation in continuous mode.

The process and the device according to the invention as described above, for example the devices as described in FIGS. 1A, 1B, 6, 7, 8, 9, 10, 11, 12 and 13, may be used to accomplish any material transfer operation for transfer between two liquids.

This operation may in particular be a liquid/liquid extraction operation and more specifically a high-temperature liquid/liquid extraction operation. The term then used will then be a “pyrometallurgical process” and the device according to the invention will then be called a “pyrocontactor”.

This pyrometallurgical process and this pyrocontactor device find application notably in the field of reprocessing of spent nuclear fuel.

The pyrocontactor thus allows combined extraction of actinides contained in a solution of molten fluorides such as LiF/AlF₃.

By bringing the molten salts, for example LiF/AlF₃, and the openwork baskets containing a molten metal, such as molten aluminium, into contact, the actinides, initially in their fluoride form, can be chemically reduced to their metallic form, and be recovered in the aluminium phase.

The contact time between the two liquid phases is generally 1 minute to 1 hour, and preferably 2 minutes to 45 minutes, for example.

The pyrocontactor prevents the saline and metallic phases from mixing. When the two liquid phases reach thermodynamic equilibrium it is then possible to raise the contactor containing material 1 (molten metal) and then position it in a second saline medium (third liquid), allowing the step of back-extraction of the actinides, for example an LiCl/AlCl₃ medium.

After this second contact, the pyrocontactor may once again be positioned in the original salts bath containing a new load of fuel to be reprocessed.

The liquid such as aluminium placed in the openwork baskets may be recycled following the back-extraction step. By this means the baskets system acts as a “chemical” pump since the extractant compound is never consumed in the process. This “chemical” pump enables one or more compound(s) in solution to be extracted and recovered without using a gravitational or acceleration field, as is the case when a settling or centrifugation system is installed to separate the phases which are brought into contact. This feature facilitates the implementation of the extraction and is of real interest for high-temperature processes.

We now describe in what follows the operating principle of the device of FIG. 1A or 1B, in order to implement the process according to the invention. A comparable description might be made for the devices of FIGS. 6, 7, and 8 to 13.

The first material in the solid state (7) is firstly placed in at least one first container (6), i.e. at least one openwork basket as described above.

The first material may be a metal such as aluminium, or a mixture or alloy of several metals.

The first material in the solid state may take the form of a single monolithic block or the form of several blocks or pieces, or alternatively the form of particles, such as a powder.

The said first container (6) is brought into contact with a volume of the second material in the solid state (4) placed in at least one second container (3), i.e. a crucible as described above.

The second material (4) may be a salt or mixture of salts.

As with the first material, the second material in the solid state (4) may take the form of a single monolithic block or the form of several blocks or pieces, or alternatively the form of particles, such as a powder.

Bringing the first container (6) into contact with the volume of the second material (4) generally consists simply in placing the first container (6) on the second material (4) in the solid state.

The generator which powers the inductor (2) is switched on and the alternating electric current flowing in the inductor generates a magnetic field.

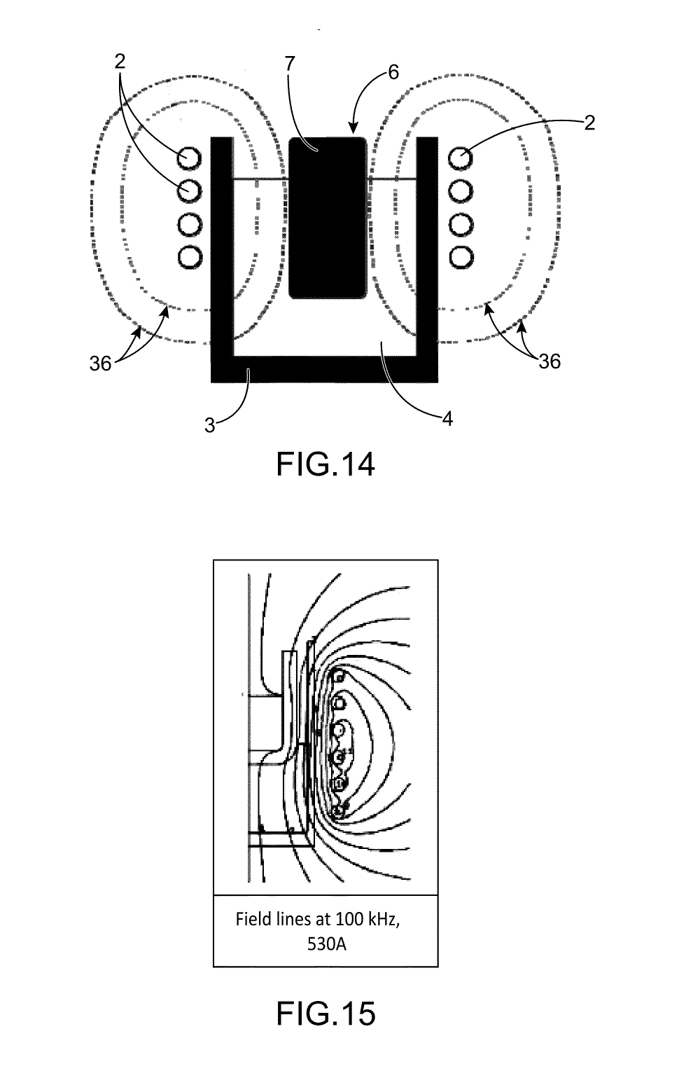

The shape of the magnetic field lines (36) is represented in FIG. 14.

The use of materials which are transparent to the electromagnetic waves generated by the inductor for the crucible (3) and for the openwork basket(s) (6) causes the field lines to penetrate as far as the metal, such as aluminium, contained in the openwork basket(s).

The magnetic field causes induced currents in the more conductive material which in this case is the metal or the alloy contained in the openwork basket(s) and which therefore acts as the susceptor of the system.

The dissipation of the energy by Joule effect allows the metal or alloy to melt.

The molten metal such as aluminium or molten alloy starts to move under the action of the Laplace forces.

The salt(s) begin to melt due to the rise in temperature caused by the heat supplied by convection and radiation from the molten metal such as aluminium or from the molten alloy.

The start of the melting of the saline medium and the appearance of an ionic conductivity in this medium enables induced currents to be generated in the salt or mixture of salts. The Joule effect caused in this manner increases the melting speed of the saline medium.

Due to this melting, the openwork basket(s) descend(s) into the saline medium under gravity alone or, alternatively, automatically or manually using a system as described above.

Electromagnetic kneading of the saline medium (4) occurs as this medium melts, again under the action of the Laplace forces.

It was seen earlier that the device or pyrocontactor according to the invention is characterised by the surprising dual use of the electromagnetism properties, the energy conservation laws of which allow a thermal effect (heating) to be combined with a fluid mechanics aspect (kneading).

The creation of a magnetic field by an alternating current, from the inductors (2), is described by the Faraday's law expressed by equation n^{o} 4 below, in which “H” represents the magnetic field and J_{source} the current density:

\vec{∇}×\vec{H}=\vec{J}_{source} (Equation n^{o} 4)

When the magnetic field created by this alternating current is brought into the presence of a conductive medium, such as for example a metal such as aluminium or a molten salt, it causes induced currents in this conductive medium, in accordance with the law of induction expressed by equation n^{o} 5 below:

$$\vec{∇} \times {\vec{E}}_{induced} = - \frac{\vec{\partial B}}{\partial t} \qquad ( Equation n°5 )$$

where B represents magnetic induction and E_{induced} the induced electric field.

Furthermore, Ohm's law applied to the conductive media to be heated is expressed by equation n^{o} 6 below:

\vec{J}_{induced}=σ\vec{.E}_{induced} (Equation n^{o} 6)

where J_{induced} represents the induced current density and the electrical conductivity.

The current induced in the metal medium such as aluminium, and in the molten salt medium, generates heat sources due to the losses by Joule effect.

The heating mode implemented according to the invention uses these heat sources.

In the presence of a magnetic field created by the inductors and of induced currents in the aluminium or molten salt the Laplace force F₁ expressed by equation n^{o} 7 below arises:

\vec{dF}ₗ=I_{induced}\vec{dl}×\vec{B} (Equation n^{o} 7)

where:
H: magnetic field, A·m⁻¹,
J_{source}: source current density, A·m⁻²,
E_{induced} induced electric field, V·m⁻¹,
B: magnetic induction, T,
t: time, s,
J_{induced}: induced current density, A·m⁻²,
σ: electrical conductivity, S·m⁻¹,
Fₗ: Laplace force, N,
I_{induced}: induced current, A,
l: unit of length along a circulation loop of the current I_{induced}, m,

Since the materials to be heated are liquid they then start to move; this phenomenon is called electromagnetic kneading.

Operational conditions may be defined allowing optimum skin thicknesses to be worked on in the case of the first material in the liquid state, which is a metal such as molten aluminium, and/or in the case of the second material in the liquid state, which is a salt such as molten LiF.

This skin thickness represents the thickness of material receiving ⅔ of the induced currents.

For example, at 100 kHz, the skin thickness in aluminium is only 0.87 mm, whereas it reaches 53 mm in the case of the molten salt LiF, which is much less conductive.

In the induction system the current directly controls the amplitude of the induced currents. The intensity of the source current thus controls the kneading speeds and the temperature field in the salt medium and metal medium, such as molten aluminium. If a system with 6 turns is used the temperature may be increased by 300 K in both media by increasing the source current from 530 A to 760 A (for a frequency of 100 kHz).

In the case of the molten salt medium, which is less conductive, and therefore more difficult to knead, the calculated and measured kneading speeds are 0.7 mm/s at 50 kHz and 2 cm/s at 150 kHz, 130 ampere-turn. At 150 kHz the velocity field is therefore 10 times higher than the field obtained by simple free convection in a temperature gradient of 50° C., as is described in detail in document [10].

In the case of the metal, such as aluminium, the expected kneading speed is 7 cm/s at 50 kHz and 6 cm/s at 150 kHz, 130 ampere-turn.

If there are 6 turns the total intensity is 780 A.

In the case of resistive heating, the speed of kneading by convection would have been close to zero, since there is no temperature gradient in aluminium, which is a thermally highly conductive metal.

If the saline medium contains actinides, the transfer of the actinides from the molten saline medium to the molten metal begins, through the openwork wall, as soon as both media are liquid.

When chemical equilibrium has been reached the openwork container(s) is/are removed from the second material in the liquid state, for example lifted, and the induction system is stopped.

The same sequence of steps may then be repeated to accomplish, for example, back-extraction of the actinides by bringing the openwork basket(s) containing the metal or a solid metal alloy into contact with a specific saline medium.

The invention will now be described with reference to the following examples, given as illustrations and non-restrictively.

### EXAMPLES

### Example 1

In this example the axisymmetrical modelisation is made of the operation of a device according to the invention as represented by the model of FIG. 1B including an induction system coupled to a device with a double boron nitride crucible, comprising an openwork basket containing aluminium and a crucible containing LiF.

The modelisation was built with computations using the Flux Expert® and Fluent/Ansys® applications.

This modelisation enabled the operational conditions allowing a satisfactory compromise between heating and magnetohydrodynamic kneading to be defined.

The results obtained during these axisymmetrical modelisation operations relate to the field lines in Wb (FIG. 15), the temperature gradient in ° K., and the velocity field in m·s⁻¹.

Use of a boron nitride material (the characteristics of which, such as the electrical conductivity, etc., are incorporated in the modelisation) for the design of the crucibles enables the field lines to penetrate as far as the interior of the system (FIG. 15). The coupling to the aluminium, which is highly conductive, generates a secondary field which is opposed to the field having given rise to it. This phenomenon explains the particular shape of the field lines, which seems to be repelled on the edge of the inner crucible.

The temperature gradient confirms that the medium heats and melts at a temperature of around 1,300 K. This result is obtained after approximately ten minutes of heating.

However, from a practical standpoint it is advised to work at a lower temperature (approximately 1,100 K) to maintain the stability of the boron nitride material with regard to the aluminium ([14] J. Mater. Sci. (2007)), (([15] J. Mater. Sci (1991)).

Finally, the mechanical modelisation of the fluids indicates the existence of a velocity field of some ten cm/s in the aluminium, and of the order of one cm/s within the crucible on the side of the molten salts.

### Example 2

In this example tests are undertaken to validate experimentally, in inactive mode, the results of the modelisation tests set out in example 1 and in FIG. 15, in order to show the melting of the metal and of the salt associated with the existence of the electromagnetic kneading of the molten salt was indeed able to be obtained.

Indeed, the low conductivity value of the “ionic conductivity” medium may restrain the onset of the forced convection movement; the validity of the calculation must therefore be checked with a real case.

The crucible containing the salt has the same dimensions (diameter, height) as the modelled system (FIGS. 1A and 1B) used in example 1.

To facilitate the observation of the kneading of the salt the experimental device is modified to be fitted with a graphite rod several mm in diameter, which replaces the Al susceptor. This susceptor enables the melting of the salt to be initiated.

The external container or crucible may be made either of “HP” (High Pressure) boron nitride, or of “HIP” (Hot Isostatic Pressed) boron nitride.

The experiments were undertaken using an induction system consisting of 6 water-cooled turns embedded in cement to ensure that the molten materials are contained in the event of the failure of a crucible.

The generator used is an aperiodic triode with 100 kW nominal power, and effective 800 V nominal voltage. The generator is connected to an impedance adaptation system. This assembly is then connected to the copper solenoid inductor. This inductor with a diameter of 120 mm and a height of 100 mm consists of 6 turns of 10 mm external diameter and 8 mm internal diameter, with water passing through it to cool it.

The operating principle was validated by means of two tests.

The first test was undertaken with an aluminium and LiF salt configuration.

Checking that both media (metal and salt) had melted was undertaken in two stages on the basis of the following scenario: start of induction, coupling on the Al, melting of the Al, partial melting of the LiF by thermal conduction of the heat and radiation of the Al crucible, coupling of the induction on the partially melted LiF, direct melting of the LiF, keeping the whole assembly in a molten state.

The experimental conditions brought 127 g of Al and 700 g of LiF into contact. For design-related reasons the induction frequency used for the test was 10 kHz. For reference, this frequency is not the most suitable for coupling on the LiF salt, since the skin thickness is 15 cm, which is higher than the radius of the crucible (60 mm). However, under these conditions the experiment enabled it to be observed that the salt and the Al melted completely within 2 h 30, and also that the salt and the aluminium were kept in a molten state due to the induction. Putting the Al crucible in the salt crucible prevents the electromagnetic kneading from being measured.

Another test specifically intended to measure the speed of kneading of the salt was therefore undertaken at a frequency of 100 kHz. The experiment consisted in replacing the Al basket by a graphite susceptor to initiate the melting of the salt. Under these conditions a block of LiF weighing 700 g was re-melted in only 17 minutes. Once melted, the graphite susceptor was raised again, and the inductive heating deliberately switched off to solidify the upper phase of the salt. After 4 minutes the induction system was switched on again, and the conductivity of the salt allowed very rapid re-melting of the solidified portion. The liquid medium was then seeded with graphite particles, the specific gravity of which, 2.26, is close to that of LiF, namely 1.8.

These particles are monitored using a photographic system which takes a photograph every 16 hundredths of a second.

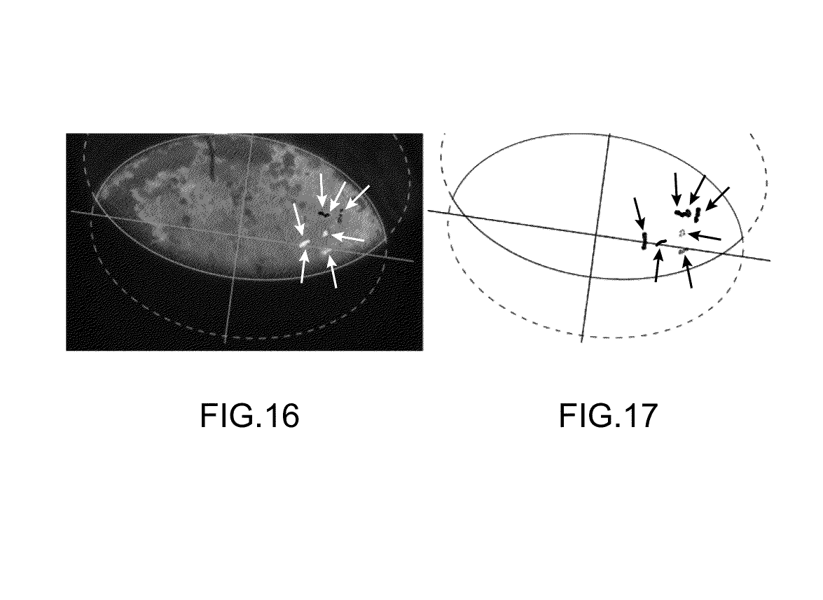

FIG. 16 is thus a photograph taken whilst measuring the speed of kneading by direct coupling of the induction system the molten salt, and FIG. 17 is a graphical transcription of the movement of the particles observed in FIG. 16.

In FIGS. 16 and 17 each arrow designates a set of points, thus forming a representative segment of the movement of an observed particle.

By monitoring the movement of the particles at the surface of the molten salt (arrows in FIGS. 16 and 17) average speeds of movement of a few cm/s were able to be measured.

This experimental result thus confirms the velocity field values obtained during the modelisation work of example 1.

FIGS. 16 and 17 prove that the use of the induction system according to the invention enables rapid heating to be combined with dynamic kneading of the different liquid media.

When cooled the crucible still retained its surface properties, notably with satisfactory mould release of the block of salt. This observation was made after 3 melting campaigns, with a total duration of 4 hours.

### REFERENCES

[1] Conocar, O., et al., “Promising pyrochemical actinide/lanthanide separation processes using aluminum”, Nuclear Science and Engineering, 2006. 153(3): p. 253-261.
[2] Conocar, O., N. Douyere, and J. Lacquement, “Extraction behavior of actinides and lanthanides in a molten fluoride/liquid aluminum system”, Journal of Nuclear Materials, 2005, 344 (1-3): p. 136-141.
[3] F. B. Hill, L. E. Kukaka, “Axial mixing and mass transfer in fused salt—liquid metal extraction column”, USAEC Report BNL-791, 1963.
[4] D. D. SOOD, “Experimental studies for reprocessing of molten salt reactor fuels”, Proc. Symp. Chemical reactions in non-aqueous media and molten salts, Osmania Univ., Hyderabad, India, Jun.-Aug. 3, 1978.
[5] P. R. Josephson, L. Burkhart, “Apparatus for treatment of molten material”, U.S. Pat. No. 3,156,534 of Oct. 11, 1964.
[6] W. E. Miller, J. B. Knighton, G. J. Bernstein “Mixer settler apparatus” U.S. Pat. No. 3,663,178 (1972).
[7] L. S. Chow, R. A. Leonard “Centrifugal pyrocontactor”, U.S. Pat. No. 5,254,076 (1993).
[8] Pravin G. “Surface tension method of and apparatus for separating immiscible liquids” U.S. Pat. No. 3,703,463, November 1972.
[9] Majer Denis John “Improvements relating to apparatus for separating two immiscible liquids” GB-A-2 127318, Nov. 4, 1984.
[10] WO-A1-2008/080853.
[11] N. Eustathopoulos “Surface tension”, Techniques de l′ingénieur [Engineering Technologies] M67, 03/1999
[12] B. Le Neindre “Surface tensions of inorganic compounds and blends”, Techniques de l'ingénieur K476-1
[13] E. W. Dewing & Paul Desclaux, “The interfacial tension between aluminium and cryolite melts saturated with alumina”, Metallurgical transactions B, volume 8B, December 1977, pp. 555-561.
[14] Pieng Shen, Hidetoshi Fujii, Kiyoshi Nogi “Effect of temperature and surface roughness on the wettability of boron nitride by molten Al”, J. Mater. Sci. (2007), 42, pp 3564-3568
[15] X. M. Xue, J. T. Wang, M. X. Quan “Wettability and spreading kinetics of liquid aluminium on boron nitride”, J. Mater. Sci. (1991) 262 pp 6391-6395
[16] Lacquement, J., et al., “Potentialities of fluoride-based salts for specific nuclear reprocessing: Overview of the R&D program at CEA”. Journal of Fluorine Chemistry, 2009, 130(1): p. 18-21.
[17] McFarlane, H. F. and M. J. Lineberry, “The IFR fuel cycle demonstration”. Progress in Nuclear Energy, 1997, 31(1-2): p. 155-173.
[18] Brunsvold, B.R.W.P.D.R.A.R., “Design and development of a cathode processor for electrochemical treatment of spent nuclear fuel”. Proceeding, 8th international conference on nuclear engineering, 2000 (ICONE-8702).
[19] Hayashi, H., et al., “Pyrochemical reprocessing method for spent nuclear fuel and induction heating system to be used in pyrochemical reprocessing method”, Japan Nuclear Cycle Development Institute.
[20] Lashley, J. C., et al., “In situ purification, alloying and casting methodology for metallic plutonium”. Journal of Nuclear Materials, 1999, 274(3): p. 315-319.
[21] WO-A1-98/05185.
[22] WO-A1-03/106009.

1.-34. (canceled)

35. A process for bringing into contact, without mixing, a first material, consisting of a metal or of an alloy of several metals, in the liquid state, and of a second material, consisting of a salt or a mixture of several salts, in the liquid state, said first material and said second material in the liquid state being immiscible, said first material being electrically conductive in the solid state and in the liquid state, and said second material being electrically conductive in the liquid state and optionally in the solid state, comprising the following successive steps:
a) the first material, in the solid state, is placed in at least one first container comprising a wall made of a refractory solid material, which is not electrically conductive, transparent to a magnetic field created by at least one inductor, and not reactive with regard to the first and the second materials, said wall comprising one or more through aperture(s); the first material in the liquid state being non-wetting with regard to the said solid material of the wall;
b) the said first container is brought into contact with a volume of the second material in the solid state, placed in at least one second container made of a refractory solid material, transparent to a magnetic field created by at least one inductor, which is not electrically conductive, and not reactive with regard to the second material;
c) the first and second containers are subjected to the action of an electromagnetic field created by at least one inductor, by which induced electrical currents are generated in the first material in the solid state, and cause the first material to melt;
d) the first material in the liquid state starts to move under the action of Laplace forces;
e) the second material in the solid state starts to melt under the effect of a heat flux originating from the first container by conduction and radiation;
f) an ionic conductivity appears in the second material, allowing induced electrical currents to develop, which accelerate the melting of the second material;
g) the second material in the liquid state starts to move under the action of Laplace forces;
h) the first material in the liquid state being in contact with the second material in the liquid state at said apertures, the first material in the liquid state is left in contact with the second material in the liquid state for a sufficient duration for an exchange, transfer of material to occur between the first material in the liquid state and the second material in the liquid state;
i) the first container is removed from the volume of the second material in the liquid state;
j) the first container is cooled until the first material returns to the solid state.

36. A process according to claim 35, in which the current passing through the inductor has an intensity of 100 to 3,000 ampere-turns and has a frequency of 20 to 400 kHz.

37. A process according to claim 35, in which the current passing through the inductor has a frequency which is chosen so as to adjust the skin thickness for the first and second materials, according to the geometry of the first and second containers and of the respective electrical conductivity properties of the first material and of the second material.

38. A process according to claim 35, in which the electromagnetic field created by the inductor generates a magnetic induction flux of between 10⁻⁶ and 10⁻³ Wb.

39. A process according to claim 35, in which the electromagnetic field created by the inductor is a sliding field.

40. A process according to claim 39, in which there are several independent inductors, where each inductor consists of a single turn through which a current flows, and between each inductor the real part of the current is phase-shifted by 90° or π/2.

41. A process according to claim 35, in which the density of the first material in the liquid state and the density of the second material in the liquid state are identical or similar.

42. A process according to claim 41, in which the density of the first material in the liquid state and the density of the second material in the liquid state are similar and do not differ by more than 10%

43. A process according to claim 35, in which the interfacial tension of the triple point, first material in the liquid state/second material in the liquid state/solid material of the wall of the first container, is high.

44. A process according to claim 43, in which the interfacial tension of the triple point, first material in the liquid state/second material in the liquid state/solid material of the wall of the first container, is higher than 0.3 N·m⁻¹.

45. A process according to claim 35, in which the first material in the liquid state has a surface tension greater than 0.3 N·m⁻¹.

46. A process according to claim 35, in which the said metal or the said alloy of several metals is chosen from among the reductive metals and alloys.

47. A process according to claim 35, in which the salt or salts is/are chosen from among the chlorides of alkaline metals, the chlorides of alkaline-earth metals, and the chlorides of aluminium; and the fluorides of alkaline metals, the fluorides of alkaline-earth metals, and the fluorides of aluminium.

48. A process according to claim 35, in which after step j) steps b) to j) are repeated, bringing the first container into contact with a volume of a third material, consisting of a salt or a mixture of several salts, different from the second material.

49. A process according to claim 35, in which the said material transfer between the first and the second materials in the liquid state is a liquid/liquid extraction during which one of the constituents of the second material in the liquid state passes into the first material in the liquid state and/or one of the constituents of the first material in the liquid state passes into the second material in the liquid state.

50. A process according to claim 49, in which the said first material is aluminium or an alloy of aluminium, and the second material comprises salts of fluorides alkaline or alkaline-earth metals containing aluminium fluoride, and in which one or more actinide fluoride(s) and one or more lanthanide fluoride(s) are dissolved; and during step h) the said actinide fluorides are chemically reduced by contact with the molten aluminium or aluminium alloy to the said actinides, which consequently pass into solution in the first material in the liquid state, whereas the lanthanide fluorides remain in the second material in the liquid state.

51. A process according to claim 50, in which, after step j), steps b) to j) are repeated by bringing the said first container(s) (6) containing the aluminium or aluminium alloy and the actinides into contact with a volume of a third material constituted by one or more chlorides of alkaline or alkaline-earth metals containing aluminium chloride, by which the actinides are chemically oxidised by contact with the said molten chlorides into actinide chlorides which pass into the third material in the liquid state, and the reduction of the aluminium chloride enables the aluminium metal, which may optionally be reused, to be generated.

52. A process according to claim 35, in which steps b) to g) are accomplished in a primary vacuum of 10⁻² absolute mbar to 10⁻¹ absolute mbar.

53. A process according to claim 35, in which step h) is accomplished in an atmosphere of an inert gas.

54. A device for carrying out the process according to claim 35, comprising:
one or more first container(s) intended to receive a first material in the solid or liquid state and comprising walls made of a refractory solid material, not electrically conductive, not reactive with regard to the first and the second materials, and transparent to a magnetic field created by at least one inductor, said walls comprising one or more through aperture(s); the first material in the liquid state being non-wetting with regard to the said solid material of the walls;
a second container intended to receive a volume of a second material in the solid or liquid state, and comprising walls made of a refractory solid material, non-electrically conductive, not reactive with regard to the second material and transparent to a magnetic field created by at least one inductor;
support for the first container(s) containing the first material in order to bring the first material into contact with the said volume of the second material, and then to remove the first material from the volume of the second material;
at least one inductor, located outside the walls of the second container, to subject the first container(s) and the second container to the action of an electromagnetic field.

55. A device according to claim 54, in which the said first container(s) and the second container are made of a material chosen from among alumina and boron nitride.

56. A device according to claim 54, in which the said apertures have a cross-section shape chosen from among circles, polygons, and rectangles having a high length/width ratio.

57. A device according to claim 54, in which said first container(s) is/are cylinders with a circular cross-section including sidewalls and a base or bottom wall.

58. A device according to claim 54, in which said first container(s) have an annular shape.

59. A device according to claim 57, in which the geometry of the bottom of said first container(s) is rounded.

60. A device according to claim 54, in which the second container is a cylinder with a circular cross-section including sidewalls and a base or bottom wall.

61. A device according to claim 54 in which the second container surrounds the first container(s) and the second container is closer to the inductor(s) than the first container(s).

62. A device according to claim 54, in which the inductor consists of an induction coil, the turns of which are positioned close to the sidewalls of the second container when said second container is cylindrical.

63. A device according to claim 54, which includes a single first container, a single second container and at least one inductor, which are symmetrical relative to a single vertical central axis.

64. A device according to claim 63, which includes a first cylindrical or annular container and a second cylindrical container, the first container and the second container being concentric, with the second container surrounding the first container, and their main axes coinciding.

65. A device according to claim 64 in which the inductor is constituted by one or more circular turn(s) surrounding the sidewall of the second container and concentric with said sidewall, the main axis of this/these turn(s) coincide(s) with the main axes of the first and of the second cylindrical containers.

66. A device according to claim 54, in which the said support of the said first container(s), to immerse the first material in the said volume of the second liquid, and to remove the first material from the said volume of second liquid, comprise a vertical rod at the lower end of which an element supporting the first container(s) is attached.

67. A device according to claim 66, in which the said element supporting the first container(s) has the shape of a carousel or circular barrel, comprising a central axis which extends the said vertical rod, several first containers being positioned in a circle concentric to the central axis of the said carousel or barrel.

68. A device according to claim 54, in which the inductor is cooled.
